(19) United States
(12) Patent Application Publication
(10) Pub. No.: US 2002/0042962 A1
(43) Pub. Date: Apr. 18, 2002

(54) Cleaning sheets comprising a polymeric additive to improve particulate pick-up and minimize residue left on surfaces and cleaning implements for use with cleaning sheets

(76) Inventors: Kenneth William Willman, Fairfield, OH (US); Michael Stephen Maile, Maineville, OH (US); Mark Leslie Kacher, Mason, OH (US); Marty Allen Vanderstelt, Cincinnati, OH (US); Laura Krebs Brown, Maineville, OH (US); Benjamin Jacob Clare, Cincinnati, OH (US); Nicola John Policicchio, Mason, OH (US); Nirav Satish Shah, Cincinnati, OH (US)

Correspondence Address: THE PROCTER & GAMBLE COMPANY, PATENT DIVISION, IVORYDALE TECHNICAL CENTER - BOX 474, 5299 SPRING GROVE AVENUE, CINCINNATI, OH, 45217, US

(21) Appl. No.: 09/821,953

(22) Filed: Mar. 30, 2001

Related U.S. Application Data
(63) Continuation-in-part of application No. 09/788,761, filed on Feb. 20, 2001.
(60) Provisional application No. 60/184,780, filed on Feb. 24, 2000.

(51) Int. Cl. A47L 13/16; A47L 13/20; B32B 7/12; B32B 15/04

(52) U.S. Cl. 15/208; 15/228; 15/231; 15/209.1; 428/343; 428/355 AC

(57) ABSTRACT

Cleaning sheets comprise an additive that is selected to enhance the pick up and retention of particulate material from surfaces, while minimizing the amount of residue left on the surface being cleaned. If the type of additive and level of additive on the cleaning sheet are not carefully selected, the sheet will leave a residue on the surface being cleaned resulting in filming and streaking of the surface that is unacceptable to consumers. The additive is preferably selected from the group consisting of a wax, an oil, and mixtures thereof. Cleaning implements comprise a mop head having a resilient bottom surface, a portion of which preferably has a substantially smooth curved profile or crown which engages a removable cleaning sheet.

### CROSS-REFERENCE TO RELATED APPLICATION

This patent application is a continuation-in-part of U.S. application Ser. No. 09/788,761 filed Feb. 20, 2001 by K. W. Willman et al., which claims the benefit of U.S. Provisional Application Ser. No. 60/184,780 filed Feb. 24, 2000 by K. W. Willman et al.

### TECHNICAL FIELD

The present invention relates to cleaning implements and cleaning sheets particularly suitable for removal and entrapment of dust, lint, hair, sand, food crumbs, grass and the like.

### BACKGROUND OF THE INVENTION

The use of nonwoven sheets for dry dust-type cleaning are known in the art. Such sheets typically utilize a composite of fibers where the fibers are bonded via adhesive, entangling or other forces. See, for example, U.S. Pat. No. 3,629,047 and U.S. Pat. No. 5,144,729. To provide a durable wiping sheet, reinforcement means have been combined with the staple fibers in the form of a continuous filament or network structure. See, for example, U.S. Pat. No. 4,808,467, U.S. Pat. No. 3,494,821 and U.S. Pat. No. 4,144,370. Also, to provide a product capable of withstanding the rigors of the wiping process, prior nonwoven sheets have employed strongly bonded fibers via one or more of the forces mentioned above. Such a cleaning sheet is described in European patent applications EP 774,229 A2 and EP 777,997 A2, which utilize continuous filaments bonded to a base sheet via heat-seal lines. While durable materials can be obtained, such strong bonding may adversely impact the materials' ability to pick up and retain particulate dirt. In an effort to address this concern, an additive consisting of mineral oil has been applied to such cleaning sheets at relatively high levels. However, a mineral oil additive, when applied to such cleaning sheets at such high levels, tends to leave an unappealing residue on surfaces that are wiped with such cleaning sheets which is unacceptable to consumers.

U.S. Pat. No. 5,599,550 issued Feb. 4, 1997 to Kohlruss et al. describes a biodegradable wax-impregnated dust cloth. However, the dust cloth disclosed by Kohlruss utilizes natural fibers and relatively high levels of wax, both of which contribute to eliminating the dust-attracting properties of the cloth.

A variety of tack cloths have been disclosed that comprise pressure sensitive adhesive and/or tackifier materials. See, e.g., U.S. Pat. No. 5,198,292; U.S. Pat. No. 3,658,578; U.S. Pat. No. 3,208,093. However, these tack cloths typically contain relatively high levels of additives and/or undesirable additives for incorporation in cleaning sheets, especially cleaning sheets used to clean household surfaces, wherein consumers find aspects of the cleaning sheet such as hand feel and glide as important to consumer acceptance.

It has thus been a desire of those skilled in the art to develop a cleaning sheet that has an ability to effectively pick up and retain particulate dirt, while maintaining the electrostatic properties and glide of the cleaning sheet, and minimizing the amount of residue left on the surface being wiped with such cleaning sheet.

In addition, while cleaning implements, such as floor mops, which utilize removable cleaning sheets are known, there is a need to provide cleaning implements which better utilize the cleaning sheet by maximizing the surface of the sheet which collects and/or traps particulate dirt. Still further, there is a need for cleaning implements which can effectively cooperate with cleaning sheets which pick up and retain particulate dirt, maintain the electrostatic properties and glide of the cleaning sheet, and minimize the amount of residue left on the surface being wiped.

### SUMMARY OF THE INVENTION

The present invention relates to cleaning sheets for removing and retaining particulate material such as dust, lint, hair, sand, food crumbs, grass and the like from surfaces, while minimizing the amount of residue left on the surface after being wiped with the cleaning sheet. The present cleaning sheets comprise an additive, whereby the type and level of additive is selected such that the ability of the cleaning sheet to pick-up and retain particulate material is improved, while the residue left on the surface is minimized. The additives contained on cleaning sheets can leave varying amounts of residue on the surface being cleaned, depending upon the type of additive A number of additive materials can be suitable for incorporation into the cleaning sheets of the present invention. Preferred additives of the present invention that are particularly useful with the present cleaning sheets are polymeric additives, especially those with specific adhesive characteristics such as specific Tack Values, Adhesive Work Values, Cohesion/Adhesion Ratios, Stringiness Values, T_{g} Values, and/or molecular weight. Other additive materials that are optional in the present invention include, but are not limited to waxes, oils, powders, and mixtures thereof. The additive material is selected in order to improve the pick-up of fine particulate matter such as dust, lint, and hair, and especially larger particulate matter typically found on household floors and surfaces such as crumbs, dirt, sand, hair, crushed food, grass clippings and mulch. In addition, the type and amount of the additive material is carefully selected in order to improve particulate pick-up of the cleaning sheet, while maintaining the ability of the cleaning sheet to easily glide across the surface being cleaned. If the cleaning sheet is too tacky as a result of the additives incorporated therein, the cleaning sheet will not easily glide across the surface, leading to consumer dissatisfaction.

The present invention further relates to mop head for a cleaning implement having a resilient bottom surface, a portion of which preferably has a substantially smooth curved profile or crown which engages the removable cleaning sheet.

The present invention further relates to a floor mop having a mop head dimensioned to receive cleaning sheets which are sized for both hand dusting and dusting with a floor mop.

The present invention further relates to a kit is comprising a mop head, or a cleaning sheet which when used with a mop head, provides a bottom surface having one of the previously described profiles for producing a repeated rocking or pivoting motion of the mop head during use. Still further, the kit preferably includes a coupling, having at least two, and, more preferably, at least three, bores which are angled relative to one another.

### BRIEF DESCRIPTION OF THE DRAWINGS

While the specification concludes with claims particularly pointing out and distinctly claiming the invention, it is believed that the present invention will be better understood from the following description taken in conjunction with the accompanying drawings in which:

FIG. 1 is a perspective view of a floor mop suitable for use with the present invention;

FIG. 2 is a perspective view of a floor mop suitable for use with the present invention, wherein a cleaning sheet is shown disposed about the mop head;

FIG. 3 is a cross sectional side view of the floor mop of FIG. 1, taken along line 3-3 thereof, wherein the upper portion of the universal joint and the entire handle have been omitted for clarity;

FIG. 4 is an enlarged cross-sectional side view of the elastic pad of the floor mop of FIG. 3;

FIG. 5 is an enlarged partial cross-sectional side view of a preferred elastic pad made in accordance with the present invention, wherein the contact surface is a tangency point;

FIG. 6 is an enlarged partial cross-sectional side view of another preferred elastic pad made in accordance with the present invention, wherein the contact surface is substantially straight;

FIG. 7 is an enlarged partial cross-sectional side view of the elastic pad of FIG. 5, wherein a cleaning sheet is disposed adjacent the pad;

FIG. 8 is an enlarged partial cross-sectional side view of the elastic pad of FIG. 6, wherein a cleaning sheet is disposed adjacent the pad;

FIG. 9 is a cross-sectional side view of an elastic pad made in accordance with the present invention, wherein the bottom surface of the elastic pad has a pyramidal surface texture;

FIG. 10 is an enlarged partial cross-sectional side view of the surface texture of the elastic pad of FIG. 9;

FIG. 11 is an enlarged partial cross-sectional side view of the preferred elastic pad of FIG. 5, wherein the radius of curvature is illustrated;

FIG. 12 is a cross-sectional side view of another preferred elastic pad for the floor mop of FIG. 1 made in accordance with the present invention, wherein the bottom surface of the elastic pad has a stepped profile;

FIG. 13 is a partial cross-sectional side view of an elastic pad, cleaning sheet, and stepped insert made in accordance with the present invention;

FIG. 14 is a partial cross-sectional side view of an elastic pad and cleaning sheet, wherein the cleaning sheet has high loft at the leading and trailing edges of the elastic pad;

FIG. 15 is a perspective view of a coupling suitable for use with the floor mop of FIG. 1;

FIG. 16 is a cross-sectional side view of the coupling of FIG. 15, taken along line 16-16 thereof;

FIG. 17 is a perspective view of the floor mop of FIG. 1 with the coupling of FIG. 16 inserted therein, wherein the mop head is in a first orientation relative to the handle;

FIG. 18 is a perspective view of the floor mop of FIG. 17, wherein the mop head is in a second orientation relative to the handle;

FIG. 19 is a perspective view showing a first embodiment of a heat-bonded cleaning sheet of the present invention;

FIG. 20 is a sectional view taken along a line III-III in FIG. 19;

FIG. 21 is a perspective view showing a second embodiment of the cleaning sheet being different from the embodiment shown by FIG. 19;

FIG. 22 is a perspective view showing a third embodiment of the cleaning sheet being also different from the embodiment shown by FIG. 19;

FIG. 23 is a digital photograph of a perspective view showing a fourth embodiment of the cleaning sheet which comprises brushy filaments, also being different from the embodiment shown by FIG. 19;

FIG. 24 is a diagram illustrating a process for making a cleaning sheet as shown in FIG. 23;

FIG. 25 is a photograph (12× magnification) of a hydroentangled cleaning sheet of the present invention, which depicts a high basis weight continuous region and a plurality of low basis weight discrete regions;

FIG. 26 is a plan view of the hydroentangled cleaning sheet depicted in FIG. 25, to facilitate discussion of the basis weight differences of the sheet;

FIG. 27 is a schematic diagram of a texture analyzer used in the Texture Analyzer Test Method described in Section V.A. herein;

FIG. 28 is a graph of force (g) versus distance (mm) generated from the Texture Analyzer Test Method described in Section V.A. herein; and

FIG. 29 is a plan view of a cleaning sheet of the present invention having a center zone and two side zones comprising a polymeric additive.

### DETAILED DESCRIPTION OF THE INVENTION

I. Definitions

As used herein, the term “comprising” means that the various components, ingredients, or steps, can be conjointly employed in practicing the present invention. Accordingly, the term “comprising” encompasses the more restrictive terms “consisting essentially of” and “consisting of”.

As used herein, the term “hydroentanglement” means generally a process for making a material wherein a layer of loose fibrous material (e.g., polyester) is supported on an apertured patterning member and is subjected to water pressure differentials sufficiently great to cause the individual fibers to entangle mechanically to provide a fabric. The apertured patterning member may be formed, e.g., from a woven screen, a perforated metal plate, and the like.

As used herein, the term “Z-dimension” refers to the dimension orthogonal to the length and width of the cleaning sheet of the present invention, or a component thereof. The Z-dimension usually corresponds to the thickness of the sheet.

As used herein, the term “X-Y dimension” refers to the plane orthogonal to the thickness of the cleaning sheet, or a component thereof. The X and Y dimensions usually correspond to the length and width, respectively, of the sheet or a sheet component.

As used herein, the term “layer” refers to a member or component of a cleaning sheet whose primary dimension is X-Y, i.e., along its length and width. It should be understood that the term “layer” is not necessarily limited to single layers or sheets of material. Thus the layer can comprise laminates or combinations of several sheets or webs of the requisite type of materials. Accordingly, the term “layer” includes the terms “layers” and “layered.” For purposes of the present invention, an “upper” layer of a cleaning sheet is a layer that is relatively further away from the surface that is to be cleaned (i.e., in the implement context, relatively closer to the implement handle during use). The term “lower” layer conversely means a layer of a cleaning sheet that is relatively closer to the surface that is to be cleaned (i.e., in the implement context, relatively further away from the implement handle during use).

As used herein, the term “total aggregate basis weight” refers to the average basis weight of an entire cleaning sheet, when viewed as a whole sheet. All percentages, ratios and proportions used herein are by weight unless otherwise specified. All references cited are incorporated herein by reference unless otherwise stated.

Reference will now be made in detail to the present preferred embodiments of the cleaning implement of the present invention, examples of which are illustrated in the accompanying drawings wherein like numerals indicate the same elements throughout the views and wherein elements having the same last two digits (e.g., 22 and 122) represent similar elements.

II. Cleaning Implements

As discussed more fully hereafter, one aspect of the present invention is, in its most preferred form, directed to a mop for use with a removable cleaning sheet which is attached to a mop head having a resilient bottom surface, a portion of which preferably has a substantially smooth curved profile or crown which engages the removable cleaning sheet. While the present invention is discussed herein with respect to a floor mop for purposes of simplicity and clarity, it will be understood that the present invention can be used with other types of mops and cleaning implements which have a cleaning sheet releasably secured there about.

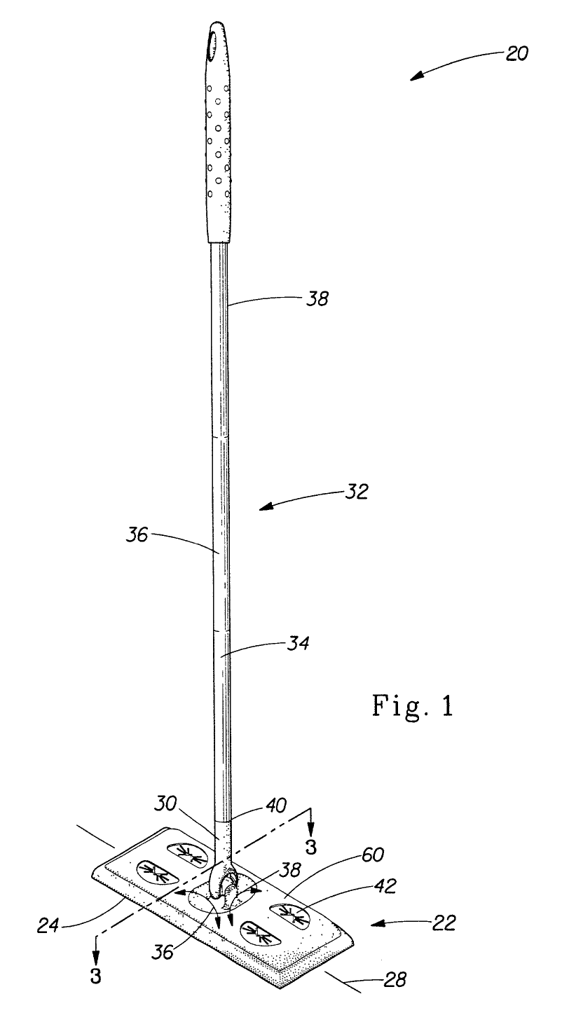

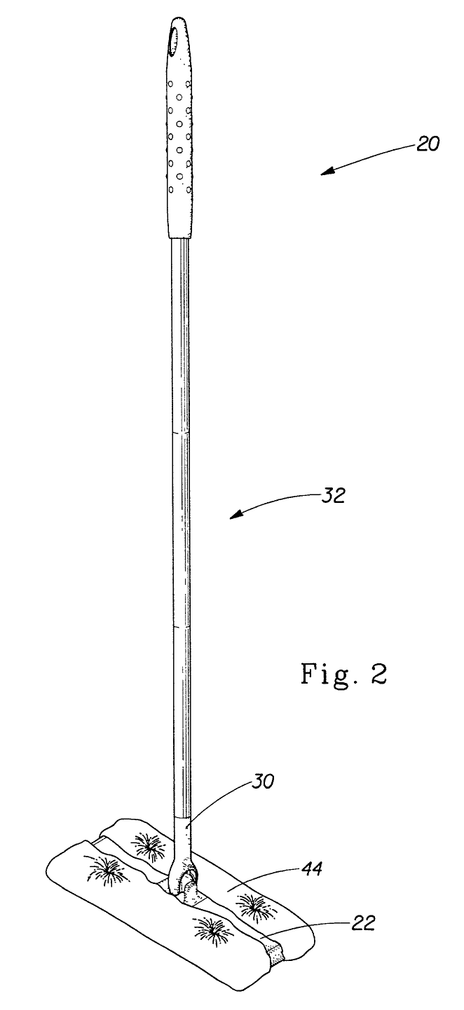

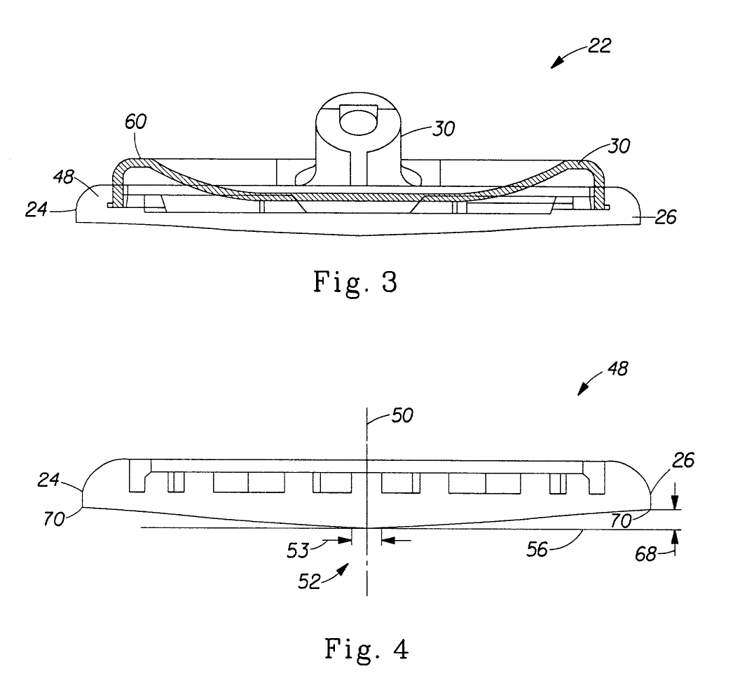

Referring to FIGS. 1 and 2, a particularly preferred floor mop 20 made in accordance with the present invention is illustrated. The floor mop 20 comprises a mop head 22 having a leading edge 24 and a trailing edge 26 (FIG. 3). As used herein, the term “leading edge” is intended to refer to the furthest edge of the mop head 22 which leads the mop head 22 when it is moved in a forward direction away from its user. Likewise, the term “trailing edge” is intended to refer to the furthest edge of the mop head 22 which trails the mop head 22 when it is moved in a forward direction away from its user. For most floor mops, the leading edge 24 and the trailing edge 26 are substantially parallel to the longitudinal axis 28 of the mop head 22, as shown in FIG. 1, wherein the longitudinal axis 28 is the axis along the length of the mop head 22.

A pivotable joint, such as the universal joint 30, interconnects the handle 32 of the mop 20 with the mop head 22. The universal joint 30 comprises two rotational axes which allow the handle 32 to pivot in directions 36 and 38. The handle 32 is interconnected, preferably threadedly interconnected, with the universal joint 30 at the connection 40. The handle 32 can be provided as a unitary structure or can comprise more than one section, preferably three sections 34, 36, and 38 which are interconnected, preferably threadedly interconnected, with each other so that the floor mop 20 can be shipped within a carton of convenient size and later assembled for use. The handle section 38 can be provided with an elastic and resilient portion suitable for gripping by a user of the floor mop 20. The mop head 22 also comprises a plurality of attachment structures 42. The attachment structures 42 are configured to receive and retain a cleaning sheet 44 about the mop head 22, as shown in FIG. 2, during use. The attachment structures 42 are preferably disposed at the corners of the mop head 22, although these locations can be varied depending upon the size and shape of the mop head 22. The attachment structures 42 are preferably provided in the form described in copending U.S. application Ser. No. 09/364,714, filed Aug. 13, 1999, naming Kingry et al. as joint inventors, the substance of which is hereby fully incorporated herein by reference. The floor mop 20 is preferably used in combination with the disposable cleaning sheet 44 which is releasably attached to the mop head 22 using the slitted attachment structures 42. The cleaning sheet can be provided in the form of a woven or non-woven fabric, as discussed more fully hereafter.

Referring to FIGS. 3 and 4 and in accordance with one aspect of the present invention, a particularly preferred mop head 22 includes a base 46 to which the universal joint 30 is attached and an elastic pad 48 which is attached, preferably adhesively attached, to the base 46, wherein the leading edge 24 and the trailing edge 26 of the mop head 22 are formed as part of the elastic pad 48. The bottom surface 50 of the elastic pad 48 engages at least a portion, and, more preferably, a substantial portion of the cleaning sheet 44 during use, as shown in FIG. 4. Surprisingly, it has been found that an elastic pad 48 having a contact surface 52 with a width 53 which is less than about 50 mm provides improved sheet cleaning performance and sheet usage efficiency (e.g., increased usage of the bottom surface of the sheet). Not intending to be bound by any theory, it is believed that the width 53 of the contact surface 52 provides a mop which can repeatedly “rock” or “pivot” or “rotate” about the contact surface 52 during any single continuous forward and/or backward sweeping motion of the mop 20, thereby providing increased dust and particulate collection across a larger percentage of the surface area of the cleaning sheet 44 as the bottom surface of the sheet repeatedly engages and disengages the hard surface to be cleaned due to the rocking motion. It is also believed that the pivoting about the contact surface 52 is further aided by a gap 54 at the leading and/or trailing edges 24 and 26 of the mop head 22 as well as the cross-sectional shape of the profile of the bottom surface, as discussed more fully hereafter. As used herein, the phrase “contact surface” is intended to refer the portion of the cross-sectional profile of the bottom surface of either the mop head 22 or the cleaning sheet 44 contacted by a straight line 56 tangent to the apex of that bottom surface, wherein the straight line 56 is substantially perpendicular to the transverse axis 58 of the mop head 22. While it is preferred that the cross-sectional profile of the bottom surface of the mop head or the cleaning sheet is the same along the entire longitudinal axis of the mop head or the cleaning sheet, any cross-sectional profile can be used herein to determine the contact surface. It will be understood that all measurements herein are based upon the theoretical or true shape and size of the mop head and/or cleaning sheet prior to deformation during use. As used herein, the term “apex” is intended to refer to that portion of the bottom surface of either the mop head 22 or the cleaning sheet 44 which is furthest from the top surface 60 of the mop head 22.

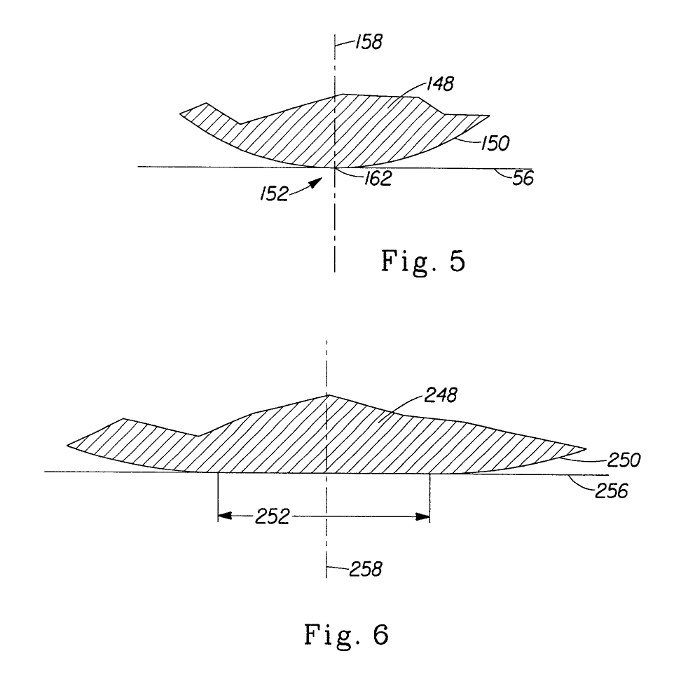

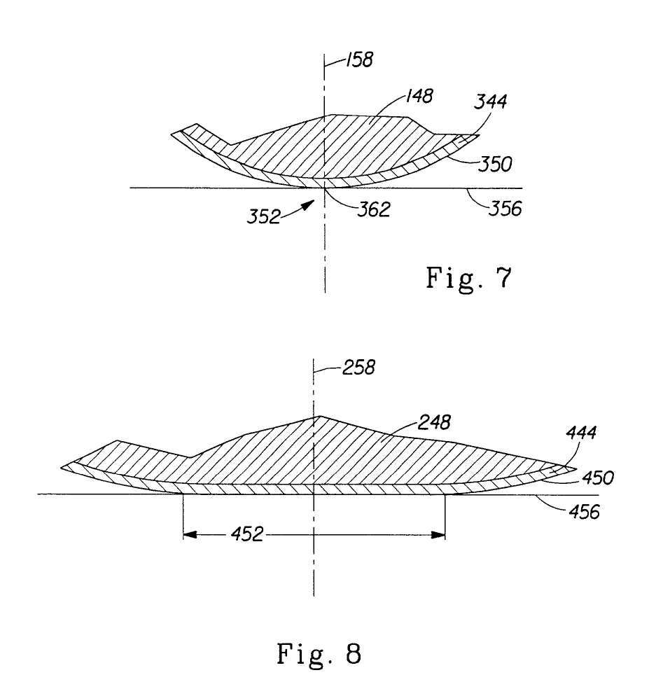

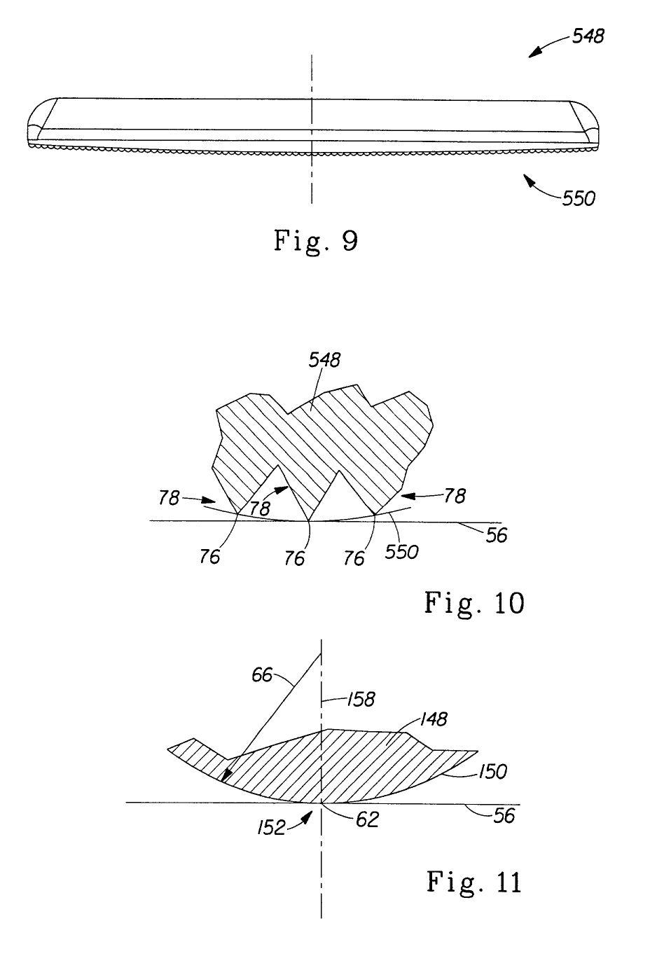

For clarity and by way of example with reference to FIGS. 5 and 6, the contact surface 152 of the mop head is the theoretical point of tangency 162 for the curved bottom surface 150 of the mop elastic pad 148 with the straight line 156, the straight line 156 being substantially perpendicular to the transverse axis 158 of the mop head. Likewise, the contact surface 252 of the elastic pad 248 of FIG. 6 is the substantially straight portion of the profile of the elastic pad 248 which contacts the straight line 256, the straight line 256 being substantially perpendicular to the transverse axis 258 of the mop head. This same technique can also be applied to a cleaning sheet attached to a mop head. For instance, as shown in FIGS. 7 and 8, the contact surface 352 of the cleaning sheet 344 is the tangency point 362 of the curved bottom surface 350 of the cleaning sheet 344 which contacts the straight line 356, this line being substantially perpendicular to the transverse axis 158 of the mop head. Likewise, the contact surface 452 of cleaning sheet 444 of FIG. 7 is the straight portion of the profile of the bottom surface of the cleaning sheet 444 which contacts the straight line 456, the straight line 456 being substantially perpendicular to the transverse axis 258 of the mop head. The previously described contact surfaces of FIGS. 5 to 8 are illustrated with respect to bottom surfaces which are substantially smooth. However, it is contemplated that the present invention can be adapted for use with bottom surfaces which are not substantially smooth, but rather, have a surface texture disposed thereon. An exemplary pyramidal surface texture 74 on the bottom surface of the elastic pad 548 is illustrated in FIGS. 9 and 10. In such instances, the contact surfaces, dimensions and profiles described for the various bottom surfaces of the mop heads herein are determined with respect to the tips 76 of the projections 78 of the surface texture 74 by creating a theoretical bottom surface profile 550 which is tangent to each tip, as shown in FIG. 10. The straight line 56 is then placed relative to the theoretical bottom surface profile 550, to determine the width 53 of the contact surface 52 of the textured bottom surface. The surface texture can be either random or repeating. Surface textures having other shaped projections (e.g., cylindrical) can also be used.

Referring again to FIG. 4, the width 53 of the contact surface 52 is preferably less than about 50 mm, and, more preferably, the width 53 of the contact surface 52 is between about 2 mm and about 50 mm. Most preferably, the width 53 of the contact surface 52 is between about 2 mm and about 20 mm. In addition to the size of the contact surface, the shape of the profile of the bottom surface 50 of the mop head 22 and/or the cleaning sheet 44 in combination with the previously described width 53 of the contact surface 52 influences whether a repeated rocking motion of the mop head is achieved during use. The profiles of the contact surface 52 are substantially curved (e.g., parabolic, hyperbolic, and other curved segments) and are preferably convex in shape, wherein the width 53 is a theoretical point contact or tangency 62 as previously discussed while for substantially straight contact surfaces (see, e.g., FIG. 6) the width 53 of the contact surface is between about 2 mm and about 50 mm.

For substantially curved profiles at the contact surface 53, it is desirable to provide a profile having a substantially continuous radius of curvature 66, as shown in FIG. 11, such that a more purely circular arc is achieved. The radius of curvature 66 can be determined for a substantially curved bottom surface by passing an arc having a constant radius through the terminuses 70 of the bottom surface and the tangency 62 of the contact surface 52 of the bottom surface. The radius of curvature 66 is preferably at least about 300 mm, and, more preferably, is at least about 1000 mm. Most preferably, the radius of curvature is between about 300 mm and about 1200 mm.

The combination of the shape of the profile (e.g., substantially curved or substantially straight) of the contact surface 52 and the width 53 of the contact surface 52 are preferably combined with a gap 68 formed between the straight line 56 defining the contact surface 52 of either the bottom surface of the mop head 22 or the bottom surface of the cleaning sheet 44 and the terminal point(s) 70 of the subject bottom surface. In other words, the term “gap” is intended to refer to the distance between the straight line 56 and the terminal point 70 of the bottom surface of either mop head 22 or the cleaning sheet 44. A sufficient gap can ensure that over a wide range of operating conditions (e.g., operating angle between the handle and mop head, mopping speed, force applied by the user, etc.), the mop head maintains the desired rocking motion. Generally for both the mop head 22 and the cleaning sheet 44, the terminal points 70 are defined by the leading edge 24 or trailing edge 26, as shown in FIG. 4. Preferably, the gap 68 is at least about 1.5 mm and, more preferably, is between about 2 mm and about 10 mm. Most preferably, the gap 68 is between about 2 mm and about 5 mm. Thus, the gap, profile shape of the contact surface, and the width of the contact surface are interrelated to varying degrees and can be changed as taught herein in order to provide a mop having a mop head which repeatedly rocks when it is moved forward and/or backward during any single continuous forward or backward motion of the mop head, such rocking motion beneficially improving the cleaning performance of the cleaning sheet 44. The synergy between the gap 68 and curved profile of the bottom surface can be represented by the ratio of the radius of curvature 66 to the gap 68, wherein the ratio is preferably between about 0.5 and about 1000. More preferably, the ratio of the radius of curvature 66 to the gap 68 is between about 1 and about 600. Most preferably, the ratio of the radius of curvature 66 to the gap 68 is between about 350 and about 600.

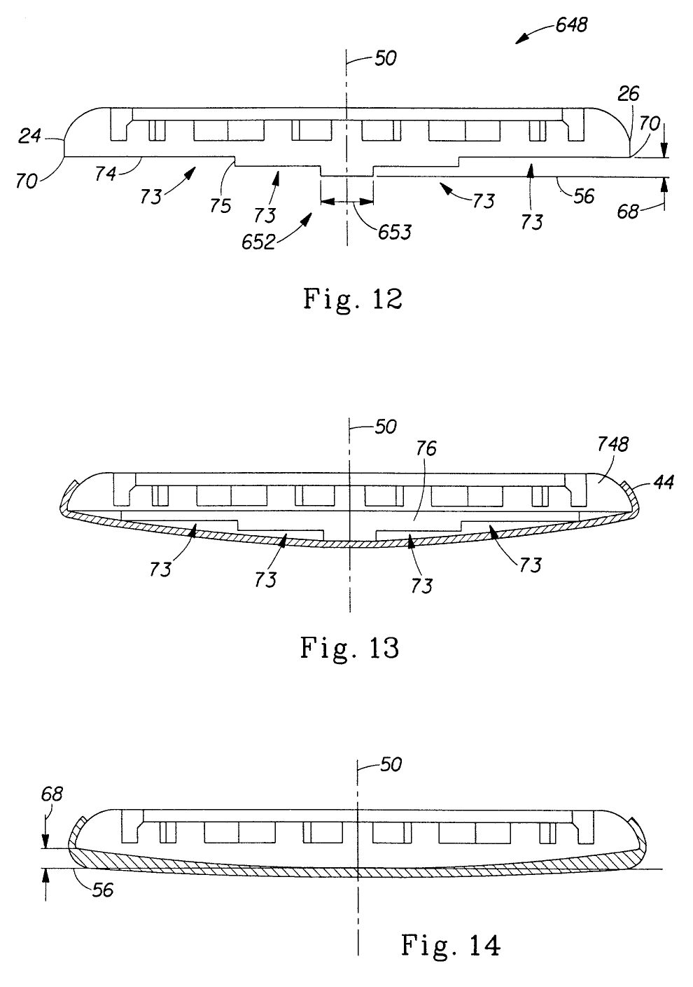

While a mop head 22 having a bottom surface which is convexly curved is most preferred, it is contemplated that bottom surfaces having a stepped profile, such as that illustrated in FIG. 12, can also provide the desired rocking motion so long as the width 653 of the linear portion of the contact surface 652 defined by the straight line 56 is at least about 2 mm. Each step 73 preferably has a longitudinally extending planar portion 74 adjacent a wall 75. While it is preferred that a plurality of steps 73 are provided so that the cleaning sheet is adequately supported during use, it is contemplated that a single step 72 could also be utilized:

As discussed, the bottom surface of the mop head 22 can be provided with a profile shape, profile size, and gap which produce the desired repeated rocking motion of the mop head during use. However, the combination of the cleaning sheet and the bottom surface of the mop head 22 can also be adapted to provide the previously described rocking motion of the mop head 22. For example with reference to FIG. 13, a tiered structure 76 with a plurality of steps 73 can be used in combination with an elastic pad 748 having a substantially smooth planar bottom surface, wherein the tiered structure 76 is incorporated into or disposed adjacent to the cleaning sheet 44 to provide a bottom surface of the cleaning sheet having the same size and/or profile characteristics as previously described for the bottom surfaces of the mop head 22. Alternatively, the cleaning sheet 44 could include an insert having a curved bottom surface which provides the bottom surface of the cleaning sheet with the previously described curved profile size and/or shape surface characteristics. Accordingly, it will be appreciated that the profile size, shape, and gap previously described with respect to the bottom surface of the mop head 22 are equally applicable to the bottom surface of a cleaning sheet.

While cleaning sheets having low calipers are particularly suitable for use with the cleaning implements of the present invention, it is contemplated that a cleaning sheet having a high caliper can also be used, wherein the high caliper allows compression of the cleaning sheet at the leading and trailing edges of the mop head (as opposed to merely conforming to the shape of the bottom surface of the mop head, as shown in FIG. 7, for cleaning sheet having a relatively low caliper). This compression allows creation of a gap for rocking of the mop head during use. The cooperation between the caliper of the cleaning sheet and the gap of the mop head 22 can be characterized by the ratio of the individual sheet caliper to the distance of the gap 68 of the mop head 22, as shown in FIG. 14. As used herein, the phrase “caliper” and its derivatives is intended to refer to the thickness of the cleaning sheet when measured according to ASTMD5729-95, wherein the presser foot pressure is 0.1 psig. Preferably the ratio of individual sheet caliper to the distance of the gap is between about 0.01 and about 0.65. More preferably, the ratio the of individual sheet caliper to the distance of the gap is between about 0.1 and about 0.6, and, most preferably, the ratio of the individual sheet caliper to the distance of the gap is between about 0.25 and about 0.6. For instances where a high caliper sheet is used with a mop head having a convexly curved bottom surface with a radius of curvature, the ratio of the radius of curvature to individual sheet caliper is preferably between about 0.01 and 1800, and, more preferably, is between about 1 and about 1400. Most preferably, the ratio of radius of curvature to individual sheet caliper is between about 200 and about 1000.

In accordance with yet another aspect of the present invention, a floor mop having a mop head dimensioned to receive cleaning sheets which are sized for both hand dusting and dusting with a floor mop will now be described. Cleaning sheets suitable for use with the floor mop 20 (such as those discussed more fully hereafter in Section III) are adapted to attract and retain various types of dust and other particulates. For instance, the cleaning sheets are particularly suited at attracting and retaining particles ranging in size from about 1×10⁻⁴ mm up to larger sized particulates which can be 2 mm and greater in height. As such, these cleaning sheets can be particularly suited for dusting surfaces by hand in addition to use with a cleaning implement, such as the floor mop 20. In order to provide a user of a cleaning implement with the greatest flexibility of use, the mop head 22 of the floor mop 20 is preferably sized to effectively retain a cleaning sheet which can be used with both the floor mop 20 and for hand dusting.

Such a cleaning sheet preferably has length (i.e., its longest dimension) to width ratio of between about 0.4 and about 1 and a sheet caliper of at least about 0.6 mm so that the cleaning sheet can adequately trap particles in both hand dusting and floor mopping applications and so that there is adequate surface area and depth for gripping the sheet during hand dusting as well as floor cleaning with the floor mop 20. More preferably, the caliper of the cleaning sheet is between about 0.6 mm and about 5 mm and most preferably is between about 0.8 mm and about 3 mm. The cleaning sheet preferably also has a length of at least about 400 mm and more preferably the length is between about 400 mm and about 500 mm. Accordingly, the mop head 22 preferably has a length (i.e., the longest dimension of the mop head) to width (i.e., the shortest dimension of the mop head) ratio of between about 0.3 and about 1 so that the hand dusting cleaning sheet can also be adequately and effectively retained about the mop head 22. More preferably, the mop head 22 has a length of at least about 400 mm. The above-described preferred cleaning sheet and mop head dimensions can be combined with a mop head having various types of bottom surfaces, such as a substantially flat bottom surface or a mop head having the textures, sizes and shapes previously described herein.

The present invention further encompasses articles of manufacture comprising the above-described hand dusting sheet (i.e. cleaning sheet) in association with a set of instructions, which can be combined with a package, carton, or other container. As used herein, the phrase “in association with” means the set of instructions is either directly printed on the cleaning sheet itself or presented in a separate manner including, but not limited to, a brochure, print advertisement, electronic advertisement, and/or verbal communication, so as to communicate the set of instructions to a consumer of the article of manufacture. The set of instructions preferably comprises the instruction to use the hand dusting sheet for hand dusting and/or with a cleaning implement, such as a floor mop, having a handle and a mop head. The set of instructions can further comprise instructions to use the hand dusting cleaning sheet with a floor mop having a mop head configured as previously described herein. For example, the instruction can instruct using the cleaning sheet with a floor mop having a mop head with a convexly curved bottom surface. Other instructions can instruct a use to assemble sections of a handle of a floor mop to complete assembly of the floor mop. Other instructions can instruct a user to attach the cleaning sheet to the mop head, move the floor mop, and then remove the cleaning sheet from the mop head.

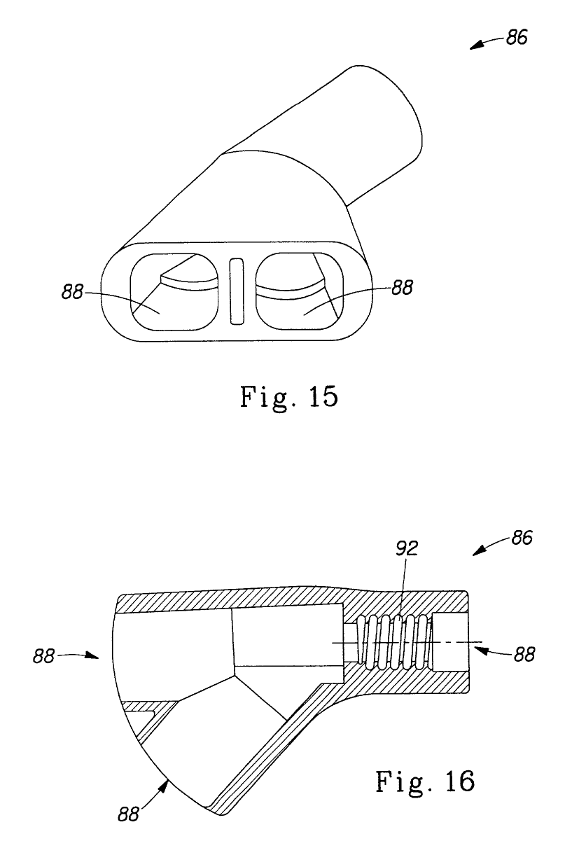

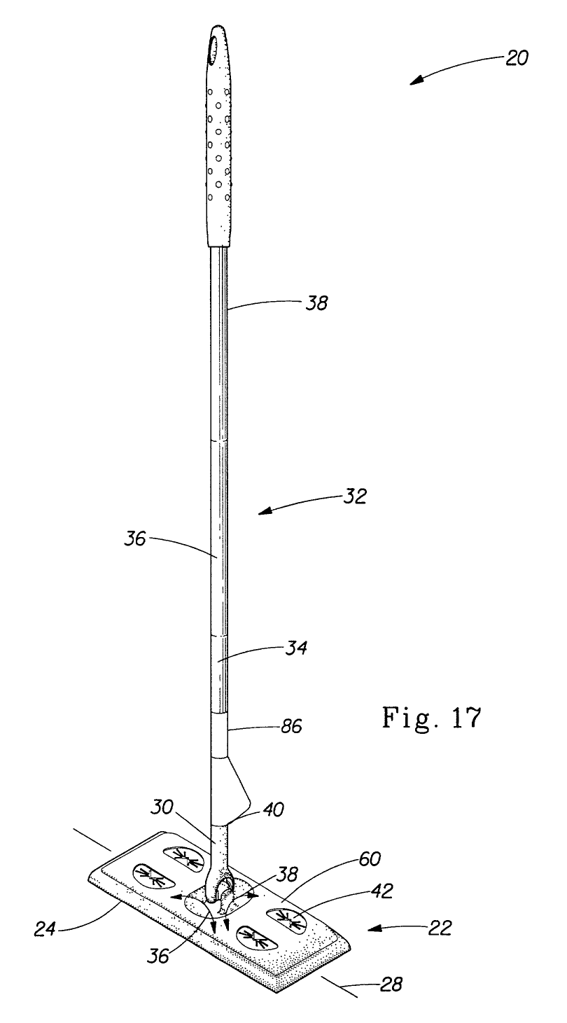

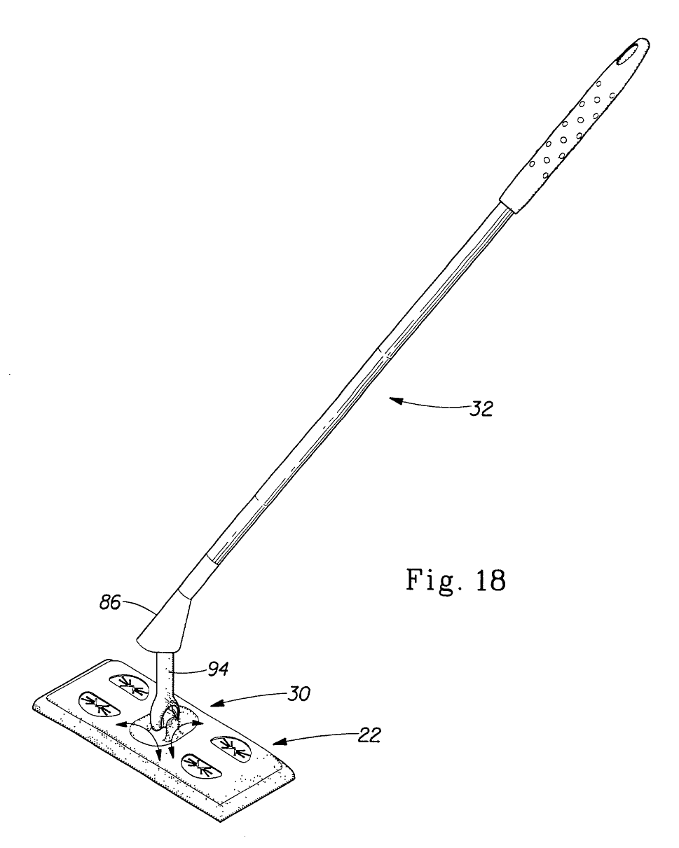

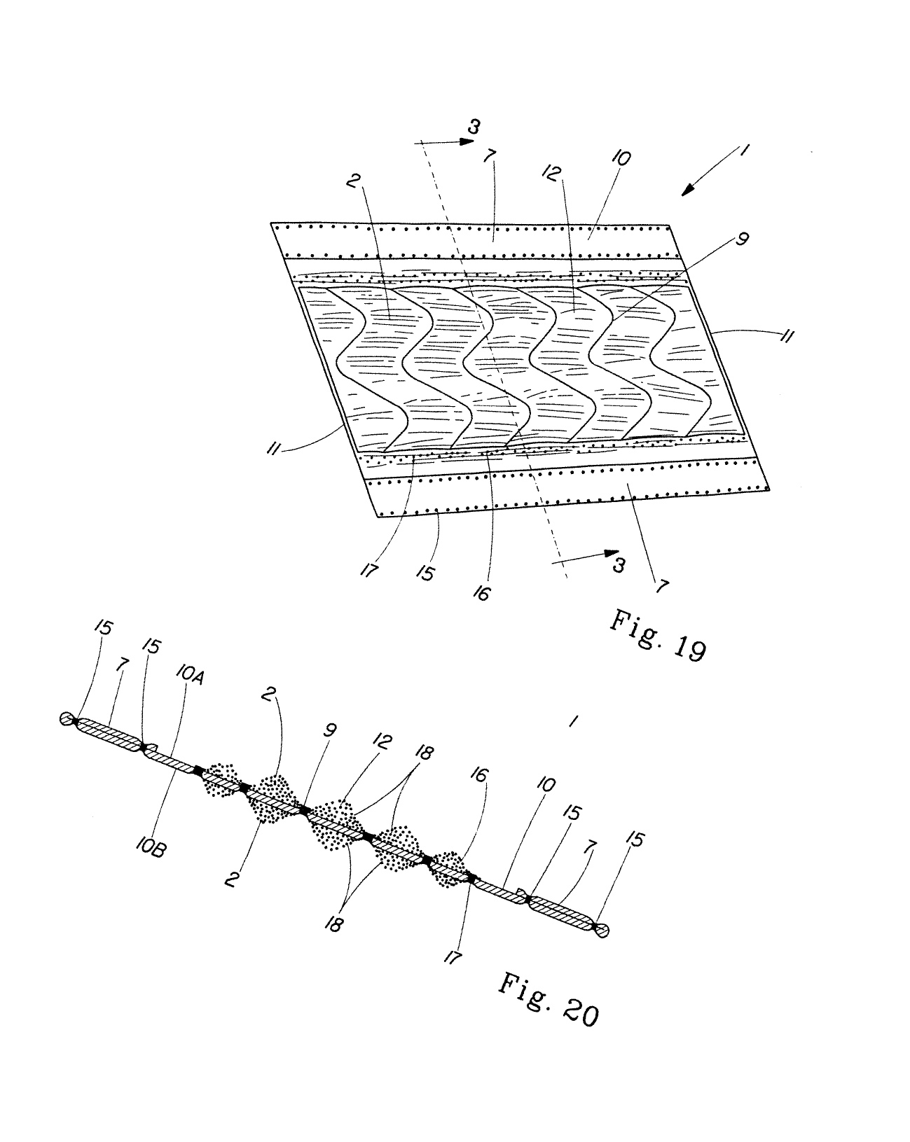

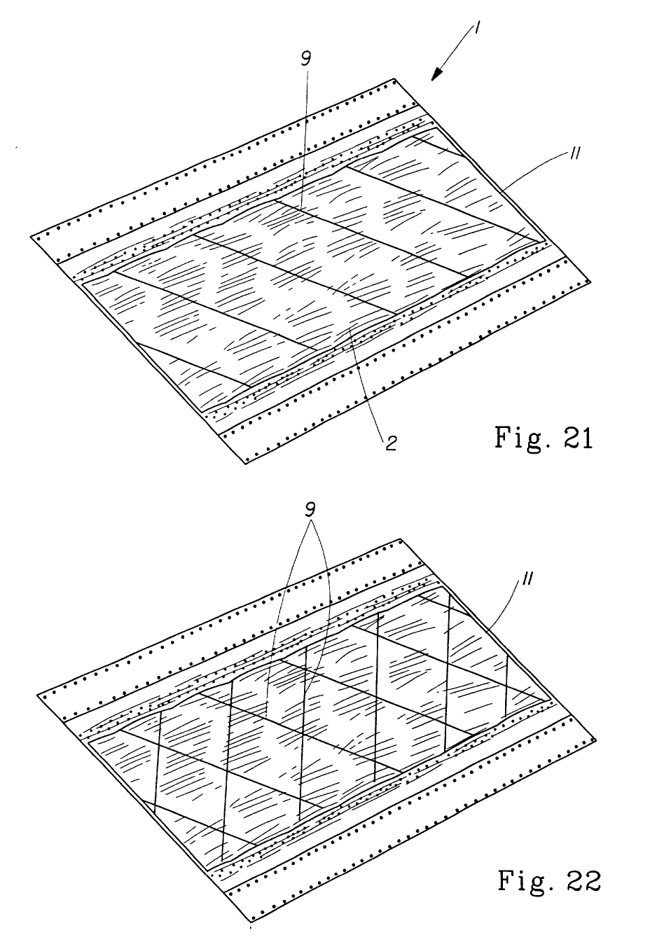

In accordance with still yet another aspect of the present invention, a kit is provided comprising a mop head, or a cleaning sheet which when used with a mop head, provides a bottom surface having one of the previously described profiles for producing a repeated rocking or pivoting motion of the mop head during use. Still further, the kit preferably includes a coupling, such as the particularly preferred coupling 86 illustrated in FIG. 15, having at least two, and, more preferably, at least three, bores 88 which are angled relative to one another. At least one bore 88 releasably receives at least one end of either the handle 32 or the universal joint 30. More preferably, at least one bore 88 has female threads 92 which threadably engages male threads of the handle 32 while the remaining two bores 88 are adapted to receive the end of the extension 94 of the universal joint 30. The angled bores 88 of the coupling 86 allow reorientation of the handle 32 relative to the mop head 22. For instance, the longitudinal axis of the extension 94 of the universal joint 30 might be substantially collinear with the longitudinal axis of the handle 32 in a first orientation, as shown in FIG. 16, while the longitudinal axis of the extension 94 of the universal joint 30 might be angled relative to the longitudinal axis of the handle 32 in a second orientation, as shown in FIG. 17. Reorientation of handle 32 relative to the universal joint 30 provides improved flexibility for cleaning hard to reach areas, such as the intersection of a wall and ceiling, etc.

The mop head 22 and universal joint 26 are preferably formed from ABS type-polymers (e.g., terpolymer from acrylonitrile), polypropylene or other plastic material by injection molding. The elastic pad 48 can formed from polyurethane by molding. The mop handle 32 can be formed from aluminum, plastic, or other structural materials.

In a preferred embodiment, the elastic pad 48 is formed from an ethylene-vinyl acetate copolymer (“EVA”). The elastic pad 48 can be formed using an injection molding process, a compression molding process, or other similar processes known in the art. Preferably, the elastic pad 48 is a compression-molded EVA pad. Non-limiting examples of suitable EVA resins to form the elastic pad 48 include those having a vinyl acetate content of from about 12% to about 25%. Suitable EVA resins are commercially available from Samsung General Chemicals under the trade name E180F and from DuPont under the trade name Elvax®.

Surprisingly, it has been found that elastic pads formed of EVA tend to generate stronger electrostatic forces as compared to other materials, such as polyurethane. This benefit is especially noticeable when a mop comprising an EVA elastic pad is used in combination with a nonwoven cleaning sheet, especially a sheet comprising synthetic fibers or a hydroentangled sheet. The improvement in electrostatic forces helps the cleaning sheet to be even more effective in picking-up and retaining particulate matter from the surface being cleaned, such as dust, dirt, and the like.

III. Cleaning Sheet

The present invention encompasses cleaning sheets comprising an additive that is selected to enhance the pick up and retention of particulate material from surfaces, while minimizing the amount of residue left on the surface being cleaned. If the type of additive and level of additive on the cleaning sheet are not carefully selected, the sheet will leave a residue on the surface being cleaned resulting in filming and streaking of the surface that is unacceptable to consumers.

The cleaning sheets of the present invention typically have a total aggregate basis weight of at least about 20 g/m², preferably at least about 40 g/m², and more preferably at least about 60 g/m². The total aggregate basis weight of the present cleaning sheets is typically no greater than about 275 g/m², preferably no greater than about 200 g/m², and more preferably no greater than about 150 g/m².

The cleaning sheets of the present invention can be made using either a woven or nonwoven process, or by forming operations using melted materials laid down on forms, especially in belts, and/or by forming operations involving mechanical actions/modifications carried out on films. The structures are made by any number of methods (e.g., spunbonded, meltblown, resin bonded, heat-bonded, air-through bonded, etc.), once the desired characteristics are known. However, the preferred structures are nonwoven, and especially those formed by hydroentanglement and/or heat-bonding as is well known in the art, since they provide highly desirable open structures. Therefore, preferred cleaning sheets are nonwoven structures having the characteristics described herein. Materials particularly suitable for forming the preferred nonwoven cleaning sheet of the present invention include, for example, natural cellulosics as well as synthetics such as polyolefins (e.g., polyethylene and polypropylene), polyesters, polyamides, synthetic cellulosics (e.g., RAYON®), and blends thereof. Also useful are natural fibers, such as cotton or blends thereof and those derived from various cellulosic sources, however these are not preferred. Preferred starting materials for making the cleaning sheets of the present invention are synthetic materials, which may be in the form of carded, spunbonded, meltblown, airlaid, or other structures. Cleaning sheets comprising synthetic materials or fibers typically have desirable electrostatic properties, which is preferred. Particularly preferred are polyesters, especially carded polyester fibers. The degree of hydrophobicity or hydrophilicity of the fibers is optimized depending upon the desired goal of the sheet, either in terms of type of soil to be removed, the type of additive that is provided, biodegradability, availability, and combinations of such considerations. In general, the more biodegradable materials are hydrophilic, but the more effective materials tend to be hydrophobic.

The cleaning sheets may be formed from a single fibrous layer, but preferably are a composite of at least two separate layers. As noted above, preferred cleaning sheets in the present invention include a variety of cleaning sheet structures, such as heat-bonded cleaning sheets and/or hydroentangled cleaning sheets.

The present cleaning sheets comprise an additive. The type and level of additive is selected such that the cleaning sheet has the ability to effectively pick-up and retain particulate material, while preferably maintaining the electrostatic properties of the cleaning sheet and minimizing the residue left on a surface being wiped with the cleaning sheet. As such, the additive is preferably non-cationic, as cationic additives can tend to diminish the electrostatic properties of the cleaning sheet.

Cleaning sheets useful in the present invention include, but are not limited to, those described in copending U.S. application Ser. No. 09/082,349, filed May 20, 1998 by Fereshtehkhou et al. (Case 6664M); copending U.S. application Ser. No. 09/082,396, filed May 20, 1998 by Fereshtehkhou et al. (Case 6798M); U.S. Pat. No. 5,525,397 issued Jun. 11, 1996 to Shizuno et al.; EP 774,229 A2 published May 21, 1997; EP 777,997 A2 published Jun. 11, 1997; and EP 09-224,895 published Sep. 2, 1997; JP 09-313,416 published Dec. 9, 1997; which are all hereby incorporated by reference herein.

A. Preferred Heat-bonded Cleaning Sheets

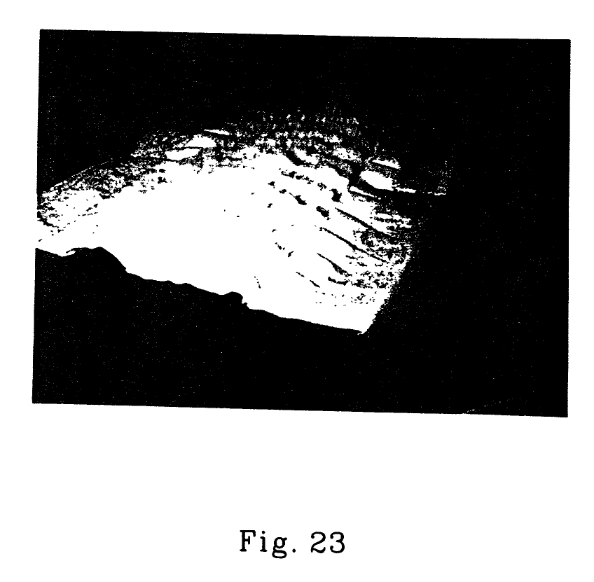

A preferred heat-bonded cleaning sheet of the present invention preferably has at least two distinct regions of differing basis weight. In a preferred embodiment, the present cleaning sheet has two distinct regions of differing basis weight and comprises a first basis weight region of relatively high basis weight and a second basis weight region of relatively low basis weight. The first region of relatively high basis weight exhibits a basis weight of typically at least about 80 g/m², preferably at least about 130 g/m², more preferably at least about 170 g/m², and even more preferably at least about 200 g/m², and typically no greater than about 300 g/m², preferably no greater than about 275 g/m², more preferably no greater than about 250 g/m², and even more preferably no greater than about 240 g/m². This first region of relatively high basis weight is preferably located in the middle of the cleaning sheet, in the Y dimension, as is shown in FIG. 23. The first region of relatively high basis weight typically accounts for at least 30%, preferably at least about 40%, more preferably at least about 45%, and even more preferably at least about 50%, of the area of the cleaning sheet. The first region of relatively high basis weight also typically accounts for no greater than about 90%, preferably no greater than about 80%, more preferably no greater than about 70%, and even more preferably no greater than about 60%, of the area of the cleaning sheet. The cleaning sheet will also preferably have a second region of relatively low basis weight, typically divided between the sides of the sheet as shown in FIG. 23, of typically no greater than about 70%, preferably no greater than about 60%, more preferably no greater than about 55%, and even more preferably no greater than about 50%, and typically at least about 10%, preferably at least about 20%, more preferably at least about 30%, and even more preferably at least about 40%, of the area of the cleaning sheet. In another aspect of the invention, there is only one macroscopic basis weight region comprising the higher basis weight material.

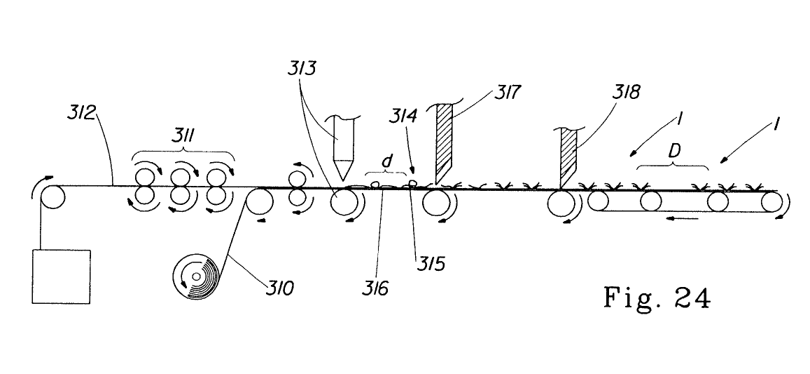

The present cleaning sheets preferably comprise brushy filaments as depicted in the cleaning sheet shown in FIG. 23 and as depicted in the process shown in FIG. 24. The brushy filaments are attached to the cleaning sheet to aid in particulate pick-up and retention. The brushy filaments are preferably formed from a bundle of polyester continuous filaments.

In regard to a cleaning sheet for use with an implement comprising a mop head and a handle as described herein, a region of relatively high basis weight is preferably located on the sheet such that the region of relatively high basis weight contacts the surface being cleaned during a typically cleaning method by wiping the surface with the cleaning sheet. The region of relatively low basis weight is preferably located on the sheet such that the region of relatively low basis weight is engaged by a holding means/gripping means located in a mop head of an implement.

### Process for Making Preferred Heat-bonded Cleaning Sheets

A process for making heat-bonded cleaning sheets that are useful in the present invention is depicted in FIG. 24. During this process, a continuous first web 310 made of polypropylene having a width of 210 mm and a basis weight of 30 g/m² is continuously fed from left to right as viewed in the diagram. Simultaneously, a tow 312 comprising a bundle of 2,000-100,000 polyester continuous filaments 315 each of 2-30 denier is continuously fed from left to right as viewed in the diagram. The tow 312 is opened or fibrillated by a set of expanding rolls 311 to form a continuous second web having a desired width and thereafter placed upon the first web 310. The first web 310 and the second web 312 are transported to a heating emboss machine 313 in which they are compressed together under heating and integrally heat-sealed along thereby formed heat-seal lines 316 transversely extending to form a continuous composite third web 314. The heat-seal lines 316 are provided so as to be spaced apart one from another by a distance d as measured longitudinally of the third web, i.e., intermittently arranged longitudinally of the third web 314. Thereafter, the second web 312 is cut by a first cutter 317 along a middle line extending parallel to and between each pair of adjacent heat-seal lines 316 in two. Then, the first web 310 is cut by a second cutter 318 into a desired length. In this manner, the individual cleaning sheets I are obtained from the third web 314. In this process, the individual basic sheets 10 are obtained from the first web 310, the brushy filaments are obtained from the second web 312, the individual filaments 15 of the brushy filaments are obtained from the continuous filaments 315 and the anchoring portions 16 are provided by the heat-seal lines 316. Preferably, each of the heat-seal lines 316 has a width of 2-10 mm and is spaced apart from the adjacent heat-seal line by a distance d of 20-200 mm. The brushy filaments or the second web or the tow 312 prior to formation of these brushy filaments are sprayed or rolled with an additive as described herein at an appropriate step of the process. In a section of the first web 310 to be cut by the second cutter 318, a distance D between each pair of adjacent heat-seal lines 316 may be dimensioned to be longer than the distance d to obtain a relatively large marginal region 7 (as shown in FIGS. 19 and 20) facilitating the cleaning sheet I to be mounted onto a mop head of a cleaning implement. In this case, the section defined between two adjacent heat-seal lines spaced from each other by the distance D necessarily provides relatively long brushy filaments and these brushy filaments must be cut to a length in conformity of the remainder brushy filaments. According to the process illustrated, a length of each filament 15 hanging down from the anchoring portion 16 corresponds to about ½ to about 9/10 of the distance d. If desired, a length of the second web 312 fed on the section of the first web 310 defined between each pair of adjacent heat-seal lines 316 may be dimensioned to be longer than the distance d in order to obtain the filaments 15 longer than ½ of the distance d.

In the process for making heat-bonded cleaning sheets according to the present invention, particular types of materials used as the basic sheet 10 and the brushy filaments are not critical insofar as they are mutually heat-sealable. However, it is generally preferable to use thermoplastic synthetic resin as the materials for these components. Additionally, the first web 310 and the second web 312 made of thermoplastic synthetic resin may be mixed with non-heat-sealable filaments such as rayon. Such non-heat-sealable filaments will be embedded in the material heat-sealed along the respective heat-seal lines 316 and fixed thereto. Furthermore, continuous plastic film may be employed for nonwoven fabric as the first web 310.

The process allows for the density of the brushy filaments planted on the basic sheet to be easily improved merely by increasing the number of filaments constituting the tow or web, since the tow or web comprising the heat-sealable filaments and the basic sheet of the heat-sealable nature are heat-sealed together followed by transversely cutting the tow or web to form the brushy filaments of said cleaning sheet.

B. Preferred Hydroentangled Cleaning Sheets

Hydroentangled cleaning sheets are particularly useful in the present invention due to their ability to effectively pick-up and retain particulate material from surfaces. In particular, nonwoven cleaning sheets made by a hydroentanglement process are highly effective. The hydro-entanglement process is well-described in U.S. Pat. No. 3,537,945. A hydroentanglement process typically involves treating a web of fibers with jets of high pressure water or other liquid which serves to “entangle” the fibers, i.e., to force the fibers from a position of alignment into one where the fibers individually are at various angles with respect to each other and become physically entangled to produce a hydroentangled fabric. The hydroentangled fabric is exceptionally strong and soft, and it also contains voids which occur between the physical junctions of the fibers which are highly effective in assisting the pick-up and retention of dust and particles. Moreover, a hydroentanglement process can be adjusted to produce a hydroentangled fabric which has visible apertures which also enhance dust and particle pick-up and retention.

The present invention encompasses a wide variety of structures of hydroentangled cleaning sheets. The cleaning sheets can have relatively uniform basis weight across the entire area of the sheet, or the cleaning sheets can have discrete regions of differing basis weight. In addition, the cleaning sheets can have relatively flat surfaces, or the cleaning sheets can exhibit macroscopic three-dimensionality.

To enhance the integrity of the present hydroentangled cleaning sheets, it is preferred to include a polymeric net (referred to herein as a “scrim” material) that is arranged with the fibrous material, e.g., though lamination via heat or chemical means such as adhesives, via hydrogentanglement. Scrim materials useful herein are described in detail in U.S. Pat. No. 4,636,419, which is incorporated by reference herein. The scrims may be formed directly at the extrusion die or can be derived from extruded films by fibrillation or by embossment, followed by stretching and splitting. The scrim may be derived from a polyolefin such as polyethylene or polypropylene, copolymers thereof, poly(butylene terephthalate), polyethylene terephthalate, Nylon 6, Nylon 66, and the like. Scrim materials are available from various commercial sources. A preferred scrim material useful in the present invention is a polypropylene scrim, available from Conwed Plastics (Minneapolis, MN).

Hydroentangled cleaning sheets suitable for the present invention include those described in copending U.S. application Ser. No. 09/082,349, filed May 20, 1998 by Fereshtehkhou et al. (Case 6664M); copending U.S. application Ser. No. 09/082,396, filed May 20, 1998 by Fereshtehkhou et al. (Case 6798M); and U.S. Pat. No. 5,525,397 issued Jun. 11, 1996 to Shizuno et al.

i. Optional Multiple Basis Weigts

Hydroentangled cleaning sheets useful in the present invention can have at least two regions, where the regions are distinguished by basis weight. In particular, the cleaning sheet can comprise one or more high basis weight regions having a basis weight of from about 30 to about 120 g/m² (preferably from about 40 to about 100 g/m², more preferably from about 50 to about 90 g/m², still more preferably from about 60 to about 80 g/m²) and one or more low basis weight regions, wherein the low basis weight region(s) have a basis weight that is not more than about 80% of the basis weight of the high basis weight region(s). Preferred cleaning sheets in this regard comprise a continuous high basis weight region and a plurality of discontinuous regions circumscribed by the continuous high basis weight region, wherein the discontinuous regions are disposed in a nonrandom, repeating pattern and have a basis weight of not more than about 80% of the basis weight of the continuous region.

Preferably, the low basis weight region(s) of the cleaning sheet will have a basis weight of not more than about 60%, more preferably not more than about 40%, and still more preferably not more than about 20%, of the basis weight of the high basis weight region(s). The cleaning sheets will preferably have an aggregate basis weight of from about 20 to about 110 g/m², more preferably from about 40 to about 100 g/m², still more preferably from about 60 to about 90 g/m². With respect to the low basis weight region(s), it is preferred that the basis weight not be zero in such regions such that macroscopic apertures are present. This is because soil will be allowed to penetrate completely through the cleaning sheet, and will not be retained therein. In other words, the entrapment level of the sheet will not be optimized in such situations.

In those embodiments where a continuous high basis weight region surrounds discrete low basis weight regions, it is preferred that at least about 5% of the cleaning sheet's total surface area be the low basis weight regions. More preferably, at least about 10%, still more preferably at least about 15%, still more preferably at least about 20%, still more preferably at least about 30%, of the cleaning sheet's total surface area will be the low basis weight regions. In those embodiments where discrete high basis weight regions are surrounded by a continuous low basis weight region, it is preferred that at least about 5% of the cleaning sheet's total surface area be the discrete high basis weight regions. More preferably, at least about 10%, still more preferably at least about 15%, still more preferably at least about 20%, still more preferably at least about 30%, of the cleaning sheet's total surface area will be the high basis weight regions.

In those preferred embodiments having a continuous high basis weight region surrounding discrete, low basis weight regions, the discrete low basis weight regions may be staggered in, or may be aligned in, either or both of the X and Y directions. Preferably, the high basis weight essentially continuous network forms a patterned network circumjacent the discrete low basis weight regions, although, as noted, small transition regions may be accommodated.

It will be clear to one skilled in the art that there may be small transition regions having a basis weight intermediate the basis weights of the high basis weight region(s) and the low basis weight region(s), which transition regions by themselves may not be significant enough in area to be considered as comprising a basis weight distinct from the basis weights of either adjacent region. Such transition regions are within the normal manufacturing variations known and inherent in producing a structure according to the present invention. It will also be recognized that within a given region (whether high or low basis weight), ordinary and expected basis weight fluctuations and variations may occur, when such given region is considered to have one basis weight. For example, if on a microscopic level, the basis weight of an interstice between fibers is measured, an apparent basis weight of zero will result when, in fact, the basis weight of such region is greater than zero. Again, such fluctuations and variations are a normal and expected result of the manufacturing process.

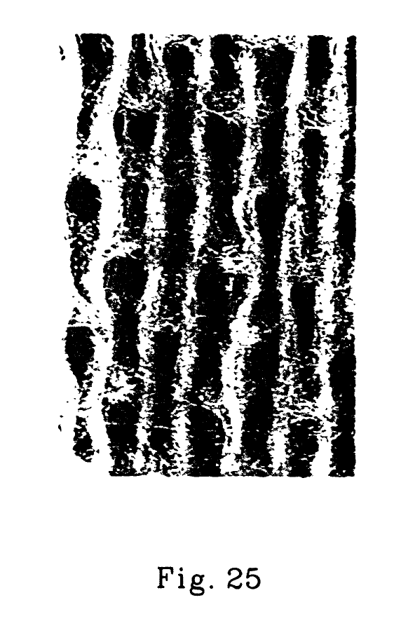

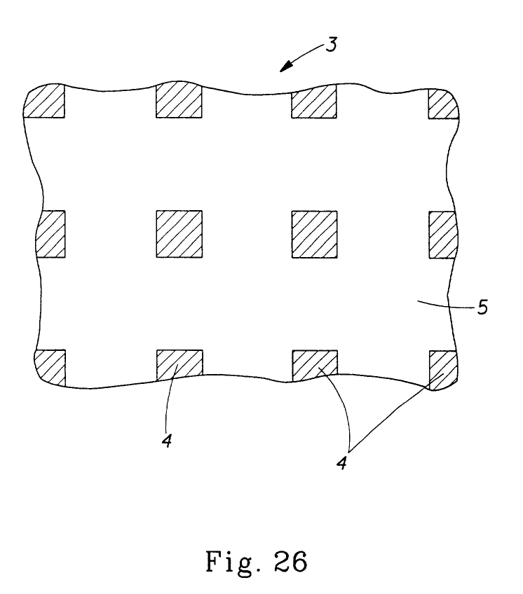

FIG. 25 is a photograph of a portion of a preferred nonwoven sheet of the present invention having a continuous high basis weight region surrounding discrete low basis weight regions. While no call-out numbers are shown, it is seen that the high basis weight continuous region appears as the light network and the low basis weight regions are the darker discrete regions. FIG. 26 is plan view of a portion of a nonwoven sheet 3 to further depict this aspect of the sheet shown in FIG. 25. In particular, in FIG. 26, nonwoven sheet 3 has a continuous high basis weight region 5 and discrete low basis weight regions 4. In this representative illustration, an optional scrim material is not shown. While the low basis weight regions 4 are depicted as being of essentially the same size and of a single well defined shape, these regions may be of differing sizes to facilitate entrapment of particles of varying size and shape. Also, it will be recognized that the shape of the low basis weight regions 4, and accordingly the continuous high basis weight region 5, may vary throughout the structure.

Differences in basis weights (within the same structure 3) between the high and low basis weight regions 5 and 4 of at least 20% are considered to be significant, and define distinct regions for purposes of the present disclosure. For a quantitative determination of basis weight in each of the regions 5 and 4, and hence a quantitative determination of the differences in basis weight between such regions 5 and 4, a quantitative method, such as image analysis of soft X-rays as disclosed in U.S. Pat. No. 5,277,761, issued to Phan et al. on Jan. 11, 1994, may be utilized, which patent is incorporated herein by reference. This method is also applicable where the regions of high and low basis weight are not arranged in a continuous/discrete pattern.

The relative area of the low basis weight regions and high basis weight region can be measured quantitatively using image analysis techniques as described in copending U.S. application Ser. No. 09/082,349, filed May 20, 1998 by Fereshtehkhou et al. (Case 6664M), which is hereby incorporated by reference.

ii. Optional Macroscopic Three-dimensionality

In one embodiment the cleaning sheets will also be macroscopically three-dimensional. These sheets are preferably relatively open structures as contrasted with, e.g., paper towels. In one such preferred embodiment, the macroscopically three-dimensional cleaning sheets have a first surface and a second surface and comprise a scrim or other contractible material. In one such preferred embodiment, the cleaning sheet has a first outward surface and a second outward surface and comprises a contractible (preferably a scrim) material, wherein the Average Peak to Peak Distance of at least one outward surface is preferably at least about 1 mm and the Surface Topography Index of that surface(s) is preferably from about 0.01 to about 5. Methods for measuring Average Peak to Peak Distance and Average Height Differential are described in detail in copending U.S. application Ser. No. 09/082,349, filed May 20, 1998 by Fereshtehkhou et al. (Case 6664M), which is hereby incorporated by reference.

Regardless of the configuration of the cleaning sheets, the Average Peak to Peak Distance of at least one outward surface will preferably be at least about 1 mm, more preferably at least about 2 mm, and still more preferably at least about 3 mm. In one embodiment, the Average Peak to Peak distance is from about 1 to about 20 mm, particularly from about 3 to about 16 mm, more particularly from about 4 to about 12 mm. The Surface Topography Index of at least one outward surface will preferably be from about 0.01 to about 10, preferably from about 0.1 to about 5, more preferably from about 0.2 to about 3, still more preferably from about 0.3 to about 2. At least one outward surface will preferably have an Average Height Differential of at least about 0.5 mm, more preferably at least about 1 mm, and still more preferably at least about 1.5 mm. The Average Height Differential of at least one outward surface will typically be from about 0.5 to about 6 mm, more typically from about I to about 3 mm.

C. Non-apertured Cleaning Sheets Having Non-random Macroscopic Three-dimensional Character

Preferred cleaning sheets herein also include non-apertured cleaning sheets having non-random macroscopic three-dimensional character. Such cleaning sheets are described in detail in copending U.S. application Ser. No. 09/729,626, filed Nov. 30, 2000 by Wong et al., which is hereby incorporated herein by reference.

D. Other Cleaning Sheets

Other cleaning sheets which are useful in the present invention include those which are spun-bonded, meltblown, airlaid, and the like.

IV. Additive

A number of additive materials can be suitable for incorporation into the cleaning sheets of the present invention. Preferred additives of the present invention that are particularly useful with the present cleaning sheets are polymeric additives, especially those with specific adhesive characteristics such as specific Tack Values, Adhesive Work Values, Cohesion/Adhesion Ratios, Stringiness Values, T_{g} Values, and/or molecular weight. Other additive materials that are optional in the present invention include, but are not limited to waxes, oils, powders, and mixtures thereof. The additive material is selected in order to improve the pick-up of fine particulate matter such as dust, lint, and hair, and especially larger particulate matter typically found on household floors and surfaces such as crumbs, dirt, sand, hair, crushed food, grass clippings and mulch. In addition, the type and amount of the additive material is carefully selected in order to improve particulate pick-up of the cleaning sheet, while maintaining the ability of the cleaning sheet to easily glide across the surface being cleaned. If the cleaning sheet is too tacky as a result of the additives incorporated therein, the cleaning sheet will not easily glide across the surface, leading to consumer dissatisfaction.

A. Polymeric Additive

The present invention encompasses the present cleaning sheets impregnated with a polymeric additive selected from a variety of acceptable polymeric additives, and mixtures thereof. Suitable polymeric additives include, but are not limited to, those selected from the group consisting of pressure sensitive adhesives, tacky polymers, and mixtures thereof. Suitable pressure sensitive adhesives comprise an adhesive polymer, which is optionally in combination with a tackifying resin, plasticizer, and/or other optional components. Suitable tacky polymers include, but are not limited to, polyisobutylene polymers, N-decylmethacrylate polymers, and mixtures thereof.

Slip agents, such as water emulsions of natural or synthetic high-melting point waxes or of natural fatty acid esters or amides (e.g. oleamide, euracamide, stearamide, or ammonium stearate) as described in U.S. Pat. No. 5,198,292 issued Mar. 30, 1993 to Lerner et al., which is incorporated herein by reference, can optionally be incorporated in the present polymeric additives. However, in a preferred embodiment, the present polymeric additives are essentially free of slip agents.

Polymeric additives tend to provide even more effective particulate pick-up, as compared to wax- and/or oil-type additives, especially in regard to larger particulate material typically found on household surfaces such as crumbs, sand, dirt, crushed food, grass clippings and mulch, and the like. However, if the type and amount of a polymeric additive is not carefully selected, the resultant cleaning sheet impregnated with the polymeric additive can become too sticky, resulting in hand feel that is unacceptable to consumers. Furthermore, if the polymeric additive is not carefully selected, the cleaning sheet will generate a coefficient of friction that is too great, resulting in a decrease in the ability of the cleaning sheet to smoothly glide across the surface being cleaned. To the average consumer who cleans household surfaces with the present cleaning sheets, the glide of the sheet is aesthetically very important.

### 1. Adhesive Characteristics of Polymeric Additive

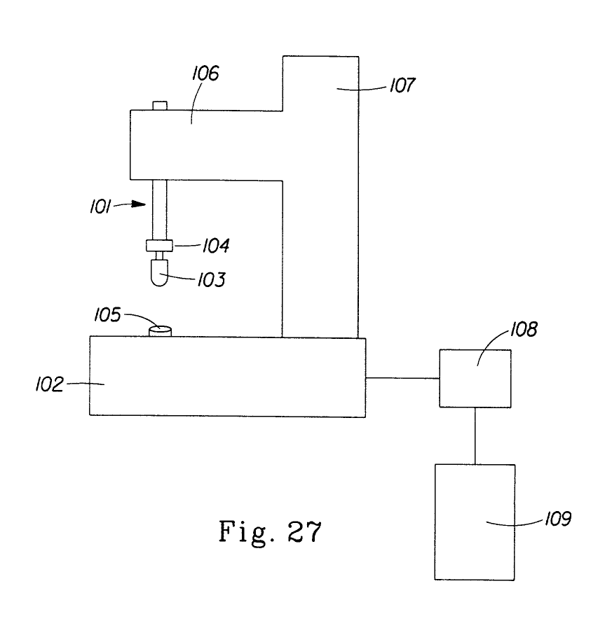

The adhesive characteristics of the present polymeric additives are important in order to create a cleaning sheet that has effective particulate pick-up performance, acceptable surface glide performance, and aesthetic appeal (e.g. hand feel). Adhesive characteristics of the present polymeric additives can be measured using a texture analyzer. A suitable texture analyzer is commercially available from Stable Micro Systems, Ltd. in Godalming, Surrey UK under the trade name TA.XT2 Texture Analyser. A test method (“Texture Analyzer Method”) for measuring the adhesive characteristics is described hereinafter in Section V.A. FIG. 27 illustrates a texture analyzer used in this test method.

The adhesive characteristics measured herein include Tack Value, Adhesive Work Value, Cohesive Strength, Adhesive Strength, Cohesive/Adhesive Ratio, and Stringiness Value. The polymeric adhesives preferred herein, including pressure sensitive adhesives and/or tacky polymers, exhibit certain adhesive characteristics in order to provide a cleaning sheet that has acceptable performance and aesthetic appeal.

### a. Adhesive Work Value

As used herein, the term “Adhesive Work Value” refers to the total bonding force, both adhesive and cohesive, of the present polymeric additive. The polymeric additive of the present invention preferably has a Adhesive Work Value within a specified range in order to provide a cleaning sheet that has effective performance and aesthetic appeal. If the Adhesive Work Value is too high, the cleaning sheet containing the polymeric additive tends to be too sticky and does not smoothly glide across the surface being cleaned. On the other hand, if Adhesive Work Value is too low, the cleaning sheet containing the polymeric additive tends to exhibit insufficient pick-up of large particulate material.

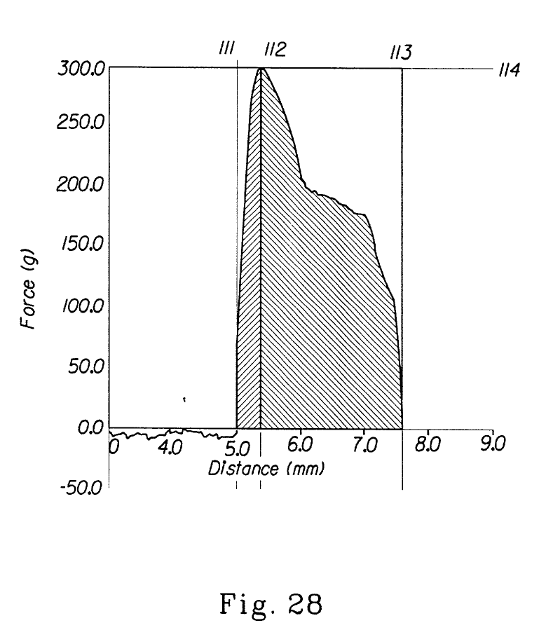

Adhesive Work Value is measured by the texture analyzer according to the Texture Analyzer Method in Section V.A. FIG. 28 illustrates a curve that is generated from the Texture Analyzer Method. The total area under the curve between line 111 and line 113 represented in the graph is equal to the Adhesive Work Value of the polymeric additive being tested. Adhesive Work Value is measured in terms of grams of force x mm.

### b. Tack Value

As used herein, the term “Tack Value” refers to the maximum adhesive strength of the polymeric additive. The polymeric additive of the present invention preferably has a Tack Value within a specified range in order to provide a cleaning sheet that has effective performance and aesthetic appeal. If the Tack Value is too high, the Adhesive Work Value also tends to be too high, resulting in a cleaning sheet that is too sticky and does not glide smoothly across the surface being cleaned. On the other hand, if Tack Value is too low, the Adhesive Work Value also tends to be too low, resulting in a cleaning sheet that tends to exhibit insufficient pick-up of large particulate material.

Tack Value is measured by the texture analyzer according to the Texture Analyzer Method in Section V.A. FIG. 28 illustrates a curve that is generated from the Texture Analyzer Method. The peak force represented by line 114 in the graph is equal to the Tack Value of the polymeric additive being tested. Tack Value is measured in terms of grams of force.

### c. Cohesive/Adhesive Ratio

As used herein, the term “Cohesive/Adhesive Ratio” refers to a ratio between the “Cohesive Strength” and the “Adhesive Strength” of a polymeric additive. “Cohesive Strength” refers to the ability of the polymeric additive to bind to itself. “Adhesive Strength” refers to the ability of the polymeric additive to bind to other materials, such as cleaning sheets, large particulate material, and the like. The Cohesive/Adhesive Ratio relates to the balance between these two forces. The polymeric additive of the present invention preferably has a Cohesive/Adhesive Ratio within a specified range in order to provide a cleaning sheet that has effective performance and aesthetic appeal. If the Cohesive/Adhesive Ratio is too high, a cleaning sheet containing the polymeric additive tends to exhibit insufficient large particulate pick-up. On the other hand, if Cohesive/Adhesive Ratio is too low, some of the polymeric additive tends to transfer from the cleaning sheet to the surface being cleaned, resulting in residue left on the surface and poor glide characteristics of the cleaning sheet.

Cohesive Strength and Adhesive Strength are measured by the texture analyzer according to the Texture Analyzer Method in Section V.A. FIG. 28 illustrates a curve that is generated from the Texture Analyzer Method. The area under the curve after the peak force—i.e. the area under the curve between line 112 and line 113—represented in the graph is equal to the Cohesive Strength of the polymeric additive being tested. The area of the curve before the peak force—i.e. the area under the curve between line 111 and line 112—represented in the graph is equal to the Adhesive Strength of the polymeric additive. The Cohesive/Adhesive Ratio is simply calculated by dividing the Cohesive Strength by the Adhesive Strength, which results in a unitless ratio.

### d. Stringiness Value

As used herein, the term “Stringiness Value” refers to the elasticity of the polymeric additive. The polymeric additive of the present invention preferably has a Stringiness Value within a specified range in order to provide a cleaning sheet that has effective performance and aesthetic appeal. If the Stringiness Value is too high, the polymeric additive tends to hold onto the surface being cleaned and the glide performance of the cleaning sheet is reduced. On the other hand, if Stringiness Value is too low, the cleaning sheet containing the polymeric additive tends to exhibit insufficient large particulate pick-up.

Stringiness Value is measured by the texture analyzer according to the Texture Analyzer Method in Section V.A. FIG. 28 illustrates a curve that is generated from the Texture Analyzer Method. The distance in which the probe of the texture analyzer is in contact with the polymeric additive being tested represented by line 112 in the graph is equal to the Stringiness Value of the polymeric additive. Stringiness Value is measured in terms of millimeters.

### 2. Pressure Sensitive Adhesives

Preferred polymeric additives in the present invention are pressure sensitive adhesives. Pressure sensitive adhesives suitable in the present invention generally comprise an adhesive polymer that is optionally in combination with a tackifying resin, plasticizer, and/or other optional ingredients. Pressure sensitive adhesives typically comprise an adhesive polymer, co-polymer, or mixtures of polymers. Preferred pressure sensitive adhesives comprise a cross-linked polymer. A preferred pressure sensitive adhesive comprises a cross-linked acrylate polymer and is essentially free of tackifiers, plasticizers, slip agents, or other resins.

### a. Adhesive Polymer and/or Copolymer

Pressure sensitive adhesives suitable as polymeric additives of the present invention preferably comprise adhesive polymers and copolymers of synthetic resins, rubbers, polyethylene, polypropylene, polyurethane, acrylics, vinyl acetate, ethylene vinyl acetate and polyvinyl alcohol.

Suitable adhesive polymers include, but are not limited to, block co-polymers containing polystyrene endblocks, and polyisoprene, polybutadiene, and/or poly ethylene-butylene midblocks; polyolefins such as polyethylene, polypropylene, amorphous polypropylene, polyisoprene, and polyethylene propylene; ethylene-vinylacetate copolymers; poly(vinyl ethylene-co-1,4-butadiene); natural rubber [poly cis-isoprene]; polyacrylic acids, preferably 2-ethylhexylacrylate and iso-octlyacrylate, and polymethacrylic acid or their salt; polydimethylsiloxane, polydiphenylsiloxane, poly methyl phenyl siloxane; polyvinyl alcohol; and mixtures thereof. Preferred pressure sensitive adhesives comprise a cross-linked adhesive polymer. A preferred pressure sensitive adhesive comprises a cross-linked acrylate adhesive polymer and is essentially free of tackifying resins, plasticizers, slip agents, or other resins.

Adhesive polymers useful for the present invention can further include thermoplastic polymers such as A-B-A triblock copolymers, A-B diblock copolymers, A-B-A-B-A-B multiblock copolymers, radial block copolymers and grafted versions thereof; homopolymers, copolymers and terpolymers of ethylene; and homopolymers, copolymers and terpolymers of propylene; and mixtures thereof. Radial block copolymers include Y-block and star polymers as well as other configurations. The A-B-A block copolymers useful herein are those described in U.S. Pat. No. 4,136,699 issued Jan. 30, 1979 to Collins et al., which is incorporated herein by reference. Examples include those polymers available under the Kraton™ G series from Shell Chemical Co. in Houston, Tex. There are various grades available including Kraton™ G-1726, Kraton™ G-1650, Kraton™ G-1651, Kraton™ G-1652, Kraton™ G-1657, all saturated A-B diblock/A-B-A triblock mixtures with ethylene/butylene midblocks; Kraton™ D-1112 a high percent A-B diblock linear styrene-isoprene-styrene polymer; Kraton™ D-1107 and Kraton™ D-1111, primarily A-B-A triblock linear styrene-isoprene-styrene block copolymers; Kraton™ D4433X, a linear styrene-isoprene-styrene “SIS” block copolymer with an oil content of 30% by weight and Kraton™ D1184, a high molecular weight styrene-buradiene-styrene “SBS” block copolymer both available from Shell Chemical Co.; Stereon™ 840A and Stereon™ 841A, A-B-A-B-A-B multiblock SBS block copolymers available from Firestone in Akron, Ohio; Europrene™ Sol T-193B, a linear SIS block copolymer available from Enichem Elastomers in New York, N.Y.; Europrene™ Sol T-190, a linear styrene-isoprene-styrene block copolymer and Europrene™ Sol T-163, a radial SBS block copolymer both also available from Enichem Elastomers; Vector™ 4461-D, a linear SBS block copolymer available from Exxon Chemical Co. in Houston, Tex.; Vector™ 4111, 4211 and 4411, fully coupled linear SIS block copolymers containing different weight percentages of styrene endblock; and Vector™ 4113, a highly coupled linear SIS block copolymer also available from Exxon Chemical Co.; and DPX-550, DPX-551 and DPX-552 radial SIS block copolymers available from Dexco Polymers in Houston, Tex. This list in not exclusive and there are numerous grades of block copolymers available from various sources for pressure sensitive adhesives, especially hot melt pressure sensitive adhesives. These polymers may be used alone, or in any combinations. These polymers are useful from about 5% to about 90% by weight in the polymeric composition.

Other adhesive polymers include a substantially linear copolymer having the general configuration A-B-A. wherein the A block can be polystyrene and the B block can be ethylene-butylene, ethylene-propylene, isoprene, butadiene or mixtures thereof, and preferably the B block is ethylene-butylene or ethylene-propylene. Adhesive polymers of this type, such as Kraton™ G-1651, have twice the molecular weight of conventional styrene-ethylene/butylene-styrene (S-EB-S) block copolymers also used in pressure sensitive adhesives. This copolymer is typically present in amounts of from about 2% to about 20% by weight, preferably from about 5% to about 20%, by weight of the pressure sensitive adhesive.

Other adhesive polymers include lower molecular weight block copolymers that can be utilized with the high molecular weight block copolymers. Some examples are A-B-A triblock copolymers, A-B diblock copolymers, A-B-A-B-A-B multiblock copolymers, radial block copolymers, and grafted versions of such copolymers including Shell Chemical's TKG-101 and RP-6912. Such A-B-A block copolymers are disclosed in Collins et al., U.S. Pat. No. 4,136,699. Some of these block copolymers are commercially available from Shell Chemical Co. under the Kraton™ G series which are S-EB-S block copolymers.

Other useful adhesive polymers include atactic polyalphaolefins such as those available from Rexene Products Co. in Dallas, Tex. under the tradename of Rextac™ such as RT-2280 and RT-2315 and RT-2585 having various amounts of ethylene and homogeneous linear or substantially linear interpolymers of ethylene with at least one C2 to C20 alphaolefin, further characterized by each said interpolymer having a polydispersity less than about 2.5 including such polymers as Exact™ 5008, an ethylene-butene copolymer, Exxpol™ SLP-0394, and ethylene-propylene copolymer, Exact™ 3031, an ethylene-hexene copolymer, all available from Dow Chemical Co. in Midland, Mich. These polymers may have to be used in small concentrations if utilized with such block copolymers as Kraton™ G-1651 to maintain compatibility without phase separation or glutinous, gel-like compositions. These concentrations can be as low as 5% by weight of the pressure sensitive adhesive.

Other adhesive polymers can be useful in the pressure sensitive adhesives of the present invention including ethylene vinyl acetate copolymers such as Elvax™ 410, a 14% vinyl acetate/400 melt index copolymer and Elvax™ 210, a 28% vinyl acetate/400 melt index copolymer, both available from DuPont Chemical Co. in Wilmington, Del.; Escorene™ UL 7505 an ethylene vinyl acetate copolymer available from Exxon Chemical Co.; Ultrathene™ UE 64904 available from Quantum Chemical Co., U.S.I. Division in Cincinnati, Ohio; and AT 1850M available from AT Polymers & Film Co. in Charlotte, N.C. Copolymers of ethylene and methyl acrylate (methacrylates as well as acrylates) are also useful including Optema™ TC-140, XS-93.04 and TC-221 available from Exxon Chemical Co.; Lotryl™ 28 MA 175 and 35 MA 05 1000 available from Elf Atochem North America in Philadelphia, Pa. Ethylene methyl acrylate copolymers are also available from Chevron under the tradename of Emac™ and from Quantum Chemical Co. under the tradename of Acrythene™. Copolymers of ethylene and n-butyl acrylate are also useful in the pressure sensitive adhesives of the present invention. They are available from Quantum Chemical Co. under the tradename of Enathene™ including EA80808, EA 89821 and EA89822; from Elf Atochem North America under the tradename of Lotry™ including 35 BA 900 and 35 BA 1000; from Exxon Chemical Co. under the tradename of Escorene™ including XW-23.AH and XW-22. These adhesive polymers can also have to be used in small concentrations with some of the block copolymers such as Kraton™ G-1651.

In a preferred embodiment, the pressure sensitive adhesive comprises an adhesive polymer that is an acrylic adhesive polymer selected from a wide variety of polymers and copolymers derived from acrylic and/or methacrylic acid, or ester, amide and nitrile derivatives thereof. Mixtures of different polymers and copolymers can be used. These polymers and copolymers preferably have a glass transition temperature of less than about 0° C. so that the mass of polymer is tacky at ambient temperatures. Examples of useful acrylate-based adhesive polymers include homopolymers and copolymers comprising isooctylacrylate, 2-ethylhexylacrylate, isoamylacrylate, nonylacrylate and butylacrylate and their copolymers or terpolymers with acrylic acid, methacrylic acid, acrylamide, methacrylamide, acrylonitrile and methacrylonitrile. It is also possible to incorporate nonpolar acrylic monomers whose homopolymers have a relatively high T_{g} such as, for example, isobornylacrylate (see, e.g., WO 95/13,331 and WO 95/13,328).

Other adhesive polymers include polyamides; polyesters; polyvinyl alcohols and copolymers thereof; polyurethanes; polystyrenes; polyepoxides; graft copolymers of vinyl monomers and polyalkylene oxide polymers and; aldehyde containing resins such as phenol-aldehyde, urea-aldehyde, melamine-aldehyde and the like.

### b. Optional Tackifying Resins

Suitable pressure sensitive adhesives can optionally be formulated with tackifying resins in order to improve adhesion and introduce tack into the pressure sensitive adhesive, to achieve the adhesive characteristics desired herein. Such resins include, among other materials, (a) natural and modified resins, (b) polyterpene resins, (c) phenolic modified hydrocarbon resins, (d) coumarone-indene resins, (e) aliphatic and aromatic petroleum hydrocarbon resins, (f) phthalate esters and (g) hydrogenated hydrocarbons, hydrogenated rosins, and hydrogenated rosin esters. Tackifying resins in hot melt adhesives that are solid at room temperature, but melt below application temperatures are preferred, since these resins lower the viscosity on application resulting in improved distribution and anchoring of the adhesive to the substrate, while not having excessive fluidity at ambient temeprature during usage. Preferably, these resins have a melting point between about 35° C. and about 200° C., more preferably between about 50° C. and about 150° C.

While tackifying resins are preferable for use in hot melt pressure sensitive adhesives, tackifying resins can also be utilized in other types of pressure sensitive adhesives as well. The tackifying resins useful herein further include aliphatic, cycloaliphatic and aromatic hydrocarbons and modified hydrocarbons and hydrogenated derivatives; terpenes and modified terpenes and hydrogenated derivatives; rosins and modified rosins and hydrogenated derivatives; and mixtures thereof. They are also available with differing levels of hydrogenation, or saturation which is another commonly used term. Useful examples include Eastotac™ H-100, H-115 and H-130 from Eastman Chemical Co. in Kingsport, Tenn. which are partially hydrogenated cycloaliphatic petroleum hydrocarbon resins with varying degress of hardness. These are available in the E grade, the R grade, the L grade and the W grade. These have differing levels of hydrogenation from least hydrogenated to most hydrogenated. The E grade has a bromine number of 15, the R grade a bromine number of 5, the L grade has a bromine number of 3 and the W grade a bromine number of 1. There is also an Eastotac™ H-142R resin available. Other useful tackifying resins include Escorez™ 1310 LC, an aliphatic hydrocarbon resin, Escorez™ 5300 and Escorez™ 5400, partially hydrogenated cycloaliphatic petroleum hydrocarbon resins, and Escorez™ 5600, a partially hydrogenated aromatic modified petroleum hydrocarbon resin all available from Exxon Chemical Co. in Houston, Tex.; Wingtack™ Extra which is an aliphatic, aromatic petroleum hydrocarbon resin available from Goodyear Chemical Co. in Akron, Ohio; Hercolite™ 2100 which is a partially hydrogenated cycloaliphatic petroleum hydrocarbon resin available from Hercules in Wilmington, Del; and Zonatac™ 105 Lite which is a styrenated terpene resin made from d-limonene and available from Arizona Chemical Co. in Panama City, Fla.

There are numerous types of rosins and modified rosins available with differing levels of hydrogenation including gum rosins, wood rosins, tall-oil rosins, distilled rosins, dimerized rosins and polymerized rosins. Some specific modified rosins include glycerol and pentaerythritol esters of wood rosins and tall-oil rosins. Commercially available grades include, but are not limited to, Sylvatac™ 1103, a pentaerythritol rosin ester available from Arizona Chemical Co., Unitac™ R-100 Lite a pentaerythritol rosin ester from Union Camp in Wayne, N.J., Zonester™ 100, a glycerol ester of tall oil rosin from Arizona Chemical Co., Permalyn™ 305, a pentaerythritol modified wood rosin available from Hercules, Inc. in Wilmington, Del. and Foral™ 105, which is a highly hydrogenated pentaerythritol rosin ester available. Sylvatac™ R-85 which is an 85° C. melt point rosin acid and Sylvatac™ 295 which is a 95° C. melt point rosin acid are both available from Arizona Chemical Co. Foral™ AX is a 75° C. melt point hydrogenated rosin acid available from Hercules Inc. Nirez™ V-2040 is a phenolic modified terpene resin available from Arizona Chemical Co.

There are many available types and grades of tackifying resins available from many companies, and one skilled in the art would recognize that this is not an exclusive list, and that the available tackifying resins are too numerous to list here. Various endblock resins are also useful in the compositions of the present invention. These include Endex™ 160, an aromatic hydrocarbon manufactured by Hercules, Inc. in Wilmington, Del.; Kristalex™ 3100 and Kristalex™ 5140, alphamethyl styrene hydrocarbons manufactured by Hercules, Inc.; and also coumarone indene resins. These tackifiers are useful in pressure sensitive adhesives at a level of from about 0% to about 65%, preferably from about 10% to about 65%, by weight of the pressure sensitive adhesive.

### c. Optional Plasticizers

Pressure sensitive adhesives can optionally comprise plasticizers. The plasticizers useful in the present pressure sensitive adhesives include, but are not limited to, mineral based oils and petroleum based oils, liquid resins, liquid elastomers, polybutene, polyisobutylene, functionalized oils such as glycerol trihydroxyoleate and other fatty oils and mixtures thereof. A plasticizer is broadly defined as a typically organic composition that can be added to pressure sensitive adhesives, such as those that comprise thermoplastics, rubbers and other resins, to improve extrudability, flexibility, workability and stretchability in the finished pressure sensitive adhesive. Any material which flows at ambient temperatures and is compatible with the block copolymer may be useful.

The most commonly used plasticizers are oils which are primarily hydrocarbon oils that are low in aromatic content and are paraffinic or naphthenic in character. The oils are preferably low in volatility, transparent and have as little color and odor as possible. This invention also contemplates the use of olefin oligomers, low molecular weight polymers, vegetable oils and their derivatives and similar plasticizing oils.

Examples of useful plasticizers in the present pressure sensitive adhesives include Calsol™ 5120, a naphthenic petroleum based oil available from Calumet Lubricants Co. in Indianapolis, Ind.; Kaydol™ White Mineral Oil, a paraffinic mineral oil available from Witco Corp. in New York, N.Y.; Parapol™ 1300, a liquid butene homopolymer available from Exxon Chemical Co. in Houston, Tex.; Indopol™ H-300, a liquid butene homopolymer, available from Amoco Corp. in Chicago, Ill.; Escorez™ 2520, a liquid aromatic petroleum based hydrocarbon resin with a pour point of 20° C., available from Exxon Chemical Co.; Regalrez™ 1018, a liquid hydrogenated aromatic hydrocarbon resin with a pour point of 18° C., available from Hercules, Inc. in Chicago, Ill.; and Sylvatac™ 5N, a liquid resin of modified rosin ester with a pour point of 5° C., available from Arizona Chemical Co. in Panama City, Fla. One skilled in the art would recognize that any generic 500 second or 1200 second naphthenic process oil would also be useful. Plasticizers are useful in the present pressure sensitive adhesives at levels of from about 0% to about 50% by weight of the pressure sensitive adhesive.

### d. Other Optional Components

Desirable optional components in the present pressure sensitive adhesives include diluents, e.g., liquid polybutene or polypropylene, petroleum waxes such as paraffin and microcrystalline waxes, polyethylene greases, hydrogenated animal, fish and vegetable fats, mineral oil and synthetic waxes such as hydrocarbon oils such as naphthionic or paraffinic mineral oils.

Diluents in hot melt adhesives that are solid at ambient temperature, but melt below application temperatures are preferred, since these diluents lower the viscosity on application resulting in improved distribution and anchoring of the adhesive to the substrate, while not having excessive fluidity during use at ambient temperature. Preferably, these resins have a melting point between about 35° C. and about 200° C., more preferably between about 50° C. and about 150° C.

Other optional components include stabilizers, antioxidants, colorants and fillers. The components and amounts of components in the present pressure sensitive adhesives are selected to provide the adhesive characteristics desired herein.

A stabilizer or antioxidant can also be used in the pressure sensitive adhesive. These compounds can be added to protect the pressure sensitive adhesive from degradation caused by reaction with oxygen induced by such things as heat, light or residual catalyst from other components of the pressure sensitive adhesive, such as a tackifying resin. Such antioxidants are commercially available from Ciba-Geigy in Hawthorne, N.Y. and include Irganox™ 565, Irganox™ 1010 and Irganox™ 1076, all hindered phenolic antioxidants. These are primary antioxidants which act as free radical scavengers and may be used alone or in combination with other antioxidants such as phosphite antioxidants like Irgafos™ 168 available from Ciba-Geigy. Phosphite antioxidants are considered secondary antioxidants, are primarily used as peroxide decomposers and are generally not used alone, but are instead used in combination with other antioxidants. Other available antioxidants are Cyanox™ LTDP, a thioether antioxidant, available from Cytec Industries in Stamford, Conn., Ethanox™ 330, a hindered phenolic antioxidant, available from Albemarle in Baton Rouge, La. Many other antioxidants are available for use by themselves, or in combination with other antioxidants. These compounds are added to pressure sensitive adhesives in small amounts, up to about 2% by weight of the pressure sensitive adhesive, and tend to have no or little effect on the adhesive characteristics of the pressure sensitive adhesive.

Other components that also could be added to pressure sensitive adhesives that tend to have no or little effect on the adhesive characteristics are pigments which add color, fluorescing agents, any compounds that mask odor and fillers to mention only a few.

Optional fillers come in the form of particulate matter, fibers and powders, or may be any material that does not interfere with the other components in the pressure sensitive adhesive. Some examples include calcium carbonate, ceramics, glass, silica, quartz, mica, treated clay, titanium dioxide, boron nitrides, graphite, carbon black, metals, barium, sulfate, talc and mixtures thereof.

### e. Adhesive Characteristics of Pressure Sensitive Adhesives

Pressure sensitive adhesives are selected for incorporation in the present cleaning sheets based on the adhesive characteristics of the pressure sensitive adhesive, including Adhesive Work Value, Tack Value, Cohesive/Adhesive Ratio, and Stringiness Value. These adhesive characteristics have been described hereinbefore in Section IV.A.1 and are measured according to the Texture Analyzer Method described hereinafter in Section V.A.

Preferred pressure sensitive adhesives typically exhibit an Adhesive Work Value at 5 grams of pressure of from about 130 to about 1000, preferably from about 160 to about 750, and more preferably from about 250 to about 650.

In general, the Tack Value at 5 grams of pressure of the pressure sensitive adhesives is from about 100 to about 500, preferably from about 150 to about 400, and more preferably from about 200 to about 350.

A typical Cohesive/Adhesive Ratio at 5 grams of pressure of the present pressure sensitive adhesives is from about 0.2 to about 20, preferably from about 1.0 to about 6.0, and more preferably from about 3.0 to about 6.0.

The present pressure sensitive adhesives normally have a Stringiness Value at 5 grams of pressure of from about 2.5 to about 12.0, preferably from about 2.5 to about 8.5, and more preferably from about 3.0 to about 5.0.

Examples of preferred pressure sensitive adhesives for use in the present cleaning sheets herein include, but are not limited to, a series of pressure sensitive adhesives commercially available from H.B. Fuller Company under the trade names HL-1496, HM-1597, HM-1902, HM-1972, HM-2713, and the like. Other preferred pressure sensitive adhesives include those available from the Rohm & Haas Company under the trade names ROBOND PS 75R, ROBOND PS 20, RHOPLEX VS; ACRONOL DS 3432, and mixtures thereof. 3. Tacky Polymers The polymeric additives for incorporation into the present cleaning sheets can also be tacky polymers. As used herein, the term “tacky polymers” refers to polymers that have higher Tack Values than those typically found in pressure sensitive adhesives, e.g. polymers having a Tack Value of at least about 300, preferably at least about 350 (Tack Value is described in more detail in Section IV.A.1.b supra). Tacky polymers are also sometimes included in pressure sensitive adhesive compositions as an optional ingredient. In a preferred embodiment herein, a tacky polymer is itself a suitable polymeric additive for incorporation in a cleaning sheet of the present invention.

Tacky polymers suitable for use as a polymeric additive for the cleaning sheets herein include, but are not limited to, polymers selected from the group consisting of: polyisobutylene polymers, alkyl methacrylate polymers, polyalkyl acrylates, and mixtures thereof, wherein the alkyl groups are C₂-C₁₈, preferably C₂-C₁₂. Preferred tacky polymers are poly n-decyl methacrylate, poly ethyl acrylate, poly n-butyl acrylate, and mixtures thereof. More preferred tacky polymers herein are polyisobutylene polymers.

### Adhesive Characteristics of Tacky Polymers

Tacky polymers are selected for incorporation in the present cleaning sheets as a polymeric additive based on the adhesive characteristics of the tacky polymer, including Adhesive Work Value, Tack Value, Cohesive/Adhesive Ratio, and Stringiness Value. These adhesive characteristics have been described hereinbefore in Section IV.A.1 and are measured according to the Texture Analyzer Method described hereinafter in Section V.A. The desired adhesive characteristics of tacky polymers can be somewhat different from adhesive characteristics of pressure sensitive adhesives due to the differing types of polymeric additives.

Suitable tacky polymers typically exhibit an Adhesive Work Value at 5 grams of pressure of from about 50 to about 1000, preferably from about 75 to about 250, and more preferably from about 100 to about 150.

In general, the Tack Value at 5 grams of pressure of the tacky polymers is from about 300 to about 500, preferably from about 300 to about 450, and more preferably from about 350 to about 400.

A typical Cohesive/Adhesive Ratio at 5 grams of pressure of the present tacky polymers is from about 0.2 to about 20, preferably from about 1.0 to about 6.0, and more preferably from about 3.0 to about 6.0.

The present tacky polymers normally have a Stringiness Value at 5 grams of pressure of from about 0.4 to about 12.0, preferably from about 0.8 to about 4, and more preferably from about 0.8 to about 2.0.

The tacky polymer additives of the present invention typically have a glass transition temperature (“T_{g}”) of at least about −150° C., preferably at least about −100° C., and more preferably at least about −80° C. Furthermore, the present tacky polymers typically have a T_{g} of no greater than about 0° C., preferably no greater than about −30° C., and more preferably no greater than about −50° C. If the tacky polymer has a T_{g} that is too high, the tacky polymer tends to be too viscous and has poor adhesive characteristics.

Additionally, the present tacky polymers typically have molecular weight of at least about 1000, preferably at least about 2500, and more preferably at least about 50,000. Furthermore, the present tacky polymers typically have a T_{g} of no greater than about 500,000, preferably no greater than about 200,000, and more preferably no greater than about 150,000. If the molecular weight of the tacky polymer is too low, the tacky polymer tends to have too low a viscosity and has unacceptably low Adhesive Strength and/or Cohesive Strength. Conversely, if the polymeric additive has a molecular weight that is too high, the tacky polymer tends to be too viscous or is a solid.

Examples of preferred tacky polymers for use in the present cleaning sheets herein include, but are not limited to, poly(n hexylmethacrylate); p-2-ethylhexyl methacrylate; polyethylacrylate; poly(lauryl acrylate); poly(n butyl acrylate); polyisobutylene (“PIB”); poly(1,4-butylene adipate); poly(n decylmethacrylate); poly(octadecylmethacrylate); poly(lauryl acrylate); poly(n butyl acrylate); poly(n-decylmethacrylate; and mixtures thereof.

In another embodiment of the invention, preferred pressure sensitive adhesives have relatively low Tack Values and Adhesive Work Values under low pressure for improved hand feel and glide, but behave similarly to tacky polymers at higher pressures for improved pick-up. This recognizes that handling a sheet containing said polymeric additive is essentially a low pressure process, while mopping a floor with said sheet containing additive involves more pressure.

The present pressure sensitive adhesives exhibit an Adhesive Work Value at 5 grams pressure of from about 30 to 150, preferably from about 40 to about 110, more preferably from about 40 to about 80, and exhibit Adhesive Work Value at 15 grams pressure of from about 50 to about 1000, preferably from about 75 to about 250, and more preferably from about 100 to about 150.

In general, the Tack Value of the present pressure sensitive adhesives at 5 grams pressure is from about 50 to about 600, preferably from about 100 to about 400, and more preferably form about 150 to about 300, and exhibit a Tack Value at 15 grams pressure of from about 300 to about 500, preferably from about 300 to about 450, and more preferably from about 350 to about 400.

A typical Cohesive/Adhesive Ratio of the present pressure sensitive adhesives at S grams pressure is from about 0.2 to about 20, preferably from about 1.0 to about 6.0, and more preferably from about 2.0 to about 6.0, and exhibit Cohesive/Adhesive Ratio at 15 grams pressure of from about 0.1 to about 10, preferably from about 0.2 to about 6.0, and more preferably from about 0.2 to about 4.0.

The present pressure sensitive adhesives normally have a Stringiness Value for both 5 grams pressure and 15 grams pressure of from about 0.4 to about 12.0, preferably from about 0.8 to about 4, and more preferably from about 0.8 to about 2.0.

An example of a preferred pressure sensitive adhesive is sold under the trade name HL 1500, available from H. B. Fuller Company.

The polymeric additives of the present invention are soluble or dispersible in a variety of solvents including, but not limited to, water; aromatic hydrocarbons, such as toluene, xylene, decahydronaphthalene and tetrahydronaphthalene; aliphatic hydrocarbons containing from 5 to 11 carbon atoms, such as pentane, hexane, and nonane; chlorinated hydrocarbons, such as methylene chloride, carbon tetrachloride, trichloroethylene, perchloroethylene, and chlorinated aromatic hydrocarbons such as chlorobenzene; and mixtures thereof.

The amount of polymeric additive impregnated onto the present cleaning sheets is another important consideration in obtaining a cleaning sheet that exhibits acceptable particulate pick-up, minimal residue, and glide. Typically, the present polymeric additives are impregnated onto the present cleaning sheets at a level of polymeric additive of no greater than about 10.0 g/m², preferably no greater than about 6.0 g/m², more preferably no greater than about 4.0 g/m², and still more preferably no greater than about 2.0 g/m². Note that the amount of polymeric additive applied to the cleaning sheet does not include the amount of solvent used to solubilize the polymeric additive. If the level of polymeric additive is too high, the cleaning sheet will feel sticky, resulting in hand feel that is aesthetically unacceptable to household consumers. Also, if the level of polymeric additive is too high, the cleaning sheet will not glide easily across the surface being cleaned, and will tend to leave a residue on the surface, resulting in filming and/or streaking of the surface that is visually unacceptable to consumers. Also, the present polymeric additives are typically impregnated onto the present cleaning sheets at a level of polymeric additive of at least about 0.1 g/m², preferably at least about 0.2 g/m², more preferably at least about 0.4 g/m², and still more preferably at least about 0.6 g/m². If the polymeric additive is impregnated onto the cleaning sheet at a level that is too low, the cleaning sheet will tend not to exhibit significantly improved particulate pick-up, with respect to cleaning sheets that contain no polymeric additive.

In a preferred embodiment, a polymeric additive is applied to a cleaning sheet in “zones”, as described hereinafter. The resulting cleaning sheet is then preferably attached to a cleaning implement, such as a floor mop as described hereinbefore, having a mop head containing an elastic pad, as described hereinbefore, and shown, for example, in FIGS. 4, 5, and 6.

### B. Optional Wax and/or Oil Additive

The cleaning performance of any of the cleaning sheets of the present invention can be further enhanced by treating the fibers of the sheet, especially surface treating, with any of a variety of additives, including surfactants or lubricants, that enhance adherence of soils to the sheet. When utilized, such additives are added to the cleaning sheet at a level sufficient to enhance the ability of the sheet to adhere soils. However, the level and type of additive must be selected to minimize the amount of residue left on the surface being cleaned by the cleaning sheet. Such additives are preferably applied to the cleaning sheet at an add-on level of at least about 0.01%, more preferably at least about 0.1%, more preferably at least about 0.5%, more preferably at least about 1%, still more preferably at least about 3%, still more preferably at least about 4%, by weight. Typically, the add-on level is from about 0.1 to about 25%, more preferably from about 0.5 to about 20%, more preferably from about I to about 15%, still more preferably from about 2 to about 10%, still more preferably from about 4 to about 8%, and most preferably from about 4 to about 6%, by weight of the dry cleaning sheet. The level and type of additive must be carefully selected to minimize the residue that is left of the surface wiped with the present cleaning sheets to leave the surface visually acceptable to consumers.

A preferred additive is a wax or a mixture of an oil (e.g., mineral oil, etc.) and a wax. Suitable waxes include various types of hydrocarbons, as well as esters of certain fatty acids (e.g., saturated triglycerides) and fatty alcohols. They can be derived from natural sources (i.e., animal, vegetable or mineral) or can be synthesized. Mixtures of these various waxes can also be used. Some representative animal and vegetable waxes that can be used in the present invention include beeswax, carnauba, spermaceti, lanolin, shellac wax, candelilla, and the like. Representative waxes from mineral sources that can be used in the present invention include petroleum-based waxes such as paraffin, petrolatum and microcrystalline wax, and fossil or earth waxes such as white ceresine wax, yellow ceresine wax, white ozokerite wax, and the like. Representative synthetic waxes that can be used in the present invention include ethylenic polymers such as polyethylene wax, chlorinated naphthalenes such as “Halowax,” hydrocarbon type waxes made by Fischer-Tropsch synthesis, and the like. Other preferred additives are supplied as mixtures of wax and oil, such as petrolatum. Such additives can be used by themselves or in combination with other wax and oils.

A preferred additive is a mixture of a wax and mineral oil, as it enhances the ability of the cleaning sheet to pick up and retain particulate material from surfaces, while minimizing the amount of residue left on the surface being wiped with the cleaning sheet. When a mixture of mineral oil and wax is utilized, the components will preferably be mixed in a ratio of oil to wax of from about 1:99 to about 7:3, more preferably from about 1:99 to about 3:2, still more preferably from about 1:99 to about 2:3, by weight. In a particularly preferred embodiment, the ratio of oil to wax is about 1:1, by weight, and the additive is applied at an add-on level of about 5%, by weight. A preferred mixture is a 1:1 mixture of mineral oil and paraffin wax.

Wax alone, such as paraffin wax, can be utilized as an additive to the present cleaning sheets. Where a wax is the only additive, the cleaning sheets are preferably comprised of synthetic fibers, so that the cleaning sheet is still able to maintain electrostatic properties to provide enhanced particulate material pick-up and retention. In any event, if the cleaning sheet comprises natural and/or synthetic fibers, an additive that consists essentially of wax is typically applied to the present cleaning sheets at an add-on level of no greater than about 4%, preferably no greater than about 3%, more preferably no greater than about 2%, and even more preferably no greater than about 1%, by weight of the cleaning sheet. These levels are preferred because if a wax additive is applied to the cleaning sheets at higher levels, the electrostatic properties of the sheet will typically be diminished, and therefore decrease the overall cleaning performance of the sheet.

Mineral oil alone can also be utilized as an additive to the present cleaning sheets. However, if only mineral oil is used, it must be at a relatively low add-on level in order to minimize the residue left on surfaces wiped with the cleaning sheet to leave the surface visually acceptable to consumers. An additive consisting essentially of mineral oil is typically applied to the present cleaning sheets at an add-on level of no greater than about 4%, preferably no greater than about 3%, more preferably no greater than about 2%, and even more preferably no greater than about 1%, by weight of the cleaning sheet.

These low levels are especially desirable when additives are applied at an effective level and preferably in a substantially uniform way to at least one discrete continuous area of the sheet. Use of the preferred lower levels, especially of additives that improve adherence of soil to the sheet, provides surprisingly good cleaning, dust suppression in the air, preferred consumer impressions, especially tactile impressions, and, in addition, the additive can provide a means for incorporating and attaching perfumes, pest control ingredients, antimicrobials, including fungicides, and a host of other beneficial ingredients, especially those that are soluble, or dispersible, in the additive. These benefits are by way of example only. Low levels of additives are especially desirable where the additive can leave a visual residue on the surfaces that are treated. As a result, the level and type of additive selected are typically important to enhance the particulate pick up and retention properties of the cleaning sheet, while minimizing the amount of residue left on the surface being wiped with the cleaning sheet.

C. Optional Powder

The present cleaning sheets can also have incorporated therein various types of powders. Powders can be desirable to incorporate in the present cleaning sheets, especially those also containing polymeric additives, in order to improve the glide characteristics (i.e. Initial Glide Value and/or In-Use Glide Value) of the cleaning sheet. Suitable powders for use herein include, but are not limited to, those selected from the group consisting of talc, starch, magnesium carbonate, and mixtures thereof.

Powders tend to reduce the tackiness of a cleaning sheet containing polymeric additive and/or impart a degree of lubricity to the lower surface of the cleaning sheet. Suitable powders typically have a particle size of from about 0.01 to about 250 microns. Powders having particle sizes within this range tend to help to reduce friction between the cleaning sheet and the surface being cleaned.

Powders are preferably applied to cleaning sheets containing polymeric additives in zones, preferably a center zone, as described hereinafter in Section IV.D.

D. Application of Additive to Cleaning Sheet

The application means for these additives preferably applies at least a substantial amount of the additive at points on the sheet that are “inside” the sheet structure. It is an especial advantage of the three dimensional structures and/or multiple basis weights, that the amount of additive that is in contact with the skin and/or surface to be treated, and/or the package, is limited, so that materials that would otherwise cause damage, or interfere with the function of the other surface, can only cause limited, or no, adverse effects. The presence of the additive inside the structure is very beneficial in that soil that adheres inside the structure is much less likely to be removed by subsequent wiping action.

Preferably, the additive does not significantly diminish the electrostatic properties of the cleaning sheet. It is preferable that the cleaning sheet of the present invention have electrostatic properties in order to facilitate pick-up and retention of particulate material, especially for fine dust particulate material.

The additive can be applied to the present cleaning sheets via a variety of application methods. Such methods include manual rolling, mechanical rolling, slotting, ultrasonic spraying, pressurized spraying, pump spraying, dipping, and the like. A preferred method of application of the additive to the cleaning sheet is by ultrasonic spraying. The additive can thus be uniformly sprayed onto the cleaning sheet.

Another preferred method of application of the additive to the cleaning sheet is by mechanical rolling. During the process of making the cleaning sheets, the sheets are fed through a set of rollers that are coated with the additive to be applied. The rollers can be coated with the additive by rotating in a pan or reservoir containing the additive. As the sheets are fed through the rollers, the additive is transferred from the rollers to the cleaning sheets. If the additive is a mixture of a wax and mineral oil, particularly in a ratio of wax to mineral oil of 1:1, the pan or reservoir containing the additive is preferably heated to a temperature of from about 32° C. to about 98° C., preferably from about 40° C. to about 65° C., in order to maintain the additive in a fluid state. In such a situation, the rollers are also preferably heated to a temperature similar to the temperature of the hot additive in a fluid state. Typically the temperature of the additive mix and the rollers are maintained at least about 5° C. to about 10° C. greater than the melting point of the additive mixture.

For small scale production of the present cleaning sheets, the additive can also be applied to the cleaning sheet via manual rolling, which comprises taking a hand-held roller, coating the roller with additive, and rolling the roller across the surface of the cleaning sheet.

Also important is the amount of surface area of the cleaning sheet that is covered with the present additives. The free fibers of the cleaning sheet, in particular hydroentangled cleaning sheets or cleaning sheets comprising brushy filaments, are especially important for small particulate pick-up. Polymeric additives are particularly important for large particulate pick-up. The polymeric additive can be applied either uniformly or non-uniformly across the surface area of the present cleaning sheet.

### Zoned Application of Additives

When polymeric additives are applied to the cleaning sheets herein, the resulting cleaning sheet can have too much tackiness that can result in the sheet having difficulty gliding across surfaces, which is unacceptable to consumers. In order to preserve electrostatic properties of the cleaning sheet and maintain consumer-acceptable glide values for the cleaning sheet, the present polymeric additives can be applied to the cleaning sheet in specific “zones” of the cleaning sheet, as opposed to uniformly distributing the polymeric additive across the entire surface of the cleaning sheet. In an alternative embodiment, the polymeric additive can be uniformly distributed across the entire surface of the cleaning sheet, and an additional additive, such as a powder and/or talc as described hereinbefore, can be applied on top of said polymeric additive, preferably in specific zones. As used herein, the term “zone” refers to specific portion of the surface area of a cleaning sheet.

The polymeric additives are preferably applied to the cleaning sheet in zones, wherein each zone can have a different level of polymeric additive in order to optimize both large particulate pick-up performance and the ability of the cleaning sheet to smoothly glide across the surface, especially when the cleaning sheet is used in conjunction with a cleaning implement as described hereinbefore and shown in FIGS. 1, 4, 5, and 6.

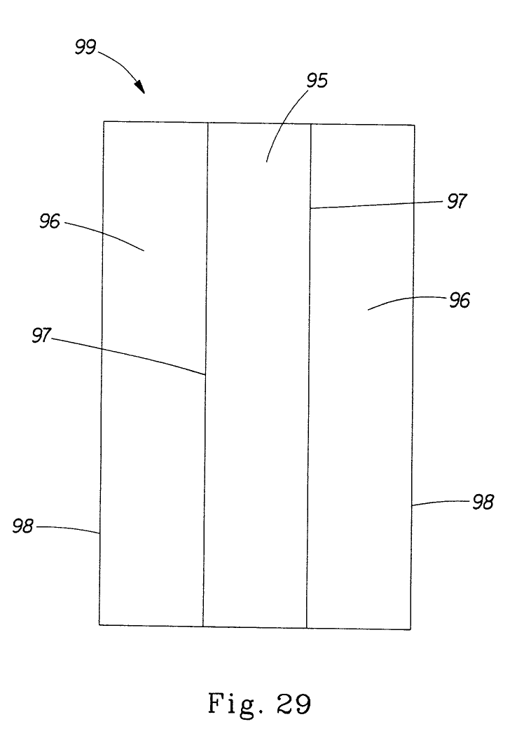

In a preferred embodiment, the present cleaning sheet has at least two zones of polymeric additive, such as a center zone and one or more side zones. As shown in FIG. 29, a center zone 95 comprises an area of the cleaning sheet 99 that spans the length of the cleaning sheet 99. However, it should be recognized that the center zone 95 need not span the entire length of the cleaning sheet. In addition, although the center zone 95 is preferably positioned in the relative center of the cleaning sheet 99, the center zone 95 need not be so positioned.

The width of the center zone 95 generally depends upon the width of the cleaning sheet 99 itself. Also, when such a cleaning sheet 99 is used with a cleaning implement such as a floor mop 20 as described hereinbefore in FIGS. 1, 4, 5, and 6, the width of the center zone 95 is preferably dependent upon the width of the contact surface 52 of the elastic pad 48 of the mop head 22 of the floor mop 20. In this case, the width of the center zone 95 is preferably equal to at least about the width of the contact surface 52, preferably greater than the width of the contact surface 52. Typically, the width of the center zone 95 will be equal to from about 2.5% to about 46%, preferably from about 8.7% to about 35%, and more preferably from about 17.4% to about 23.2%, of the total width of the cleaning sheet 99. In a preferred embodiment, the cleaning sheet 99 has a total width of about 8.625 inches and the center zone 95 is positioned in the center of the cleaning sheet 99 and has a width of from about 0.25 inches to about 4 inches, preferably from about 0.75 inches to about 3 inches, and more preferably from about 1.5 inches to about 2 inches. The length of the center zone 95 is typically equal to from about 27% to about 100%, preferably from about 54% to about 97.7%, and more preferably from about 86% to about 95.4%, of the total length of the cleaning sheet 99. In a preferred embodiment, the cleaning sheet 99 has a total length of about 11 inches and the center zone 95 has a length of 11 inches also.

The level of polymeric additive applied in a center zone of a cleaning sheet as described herein is typically from about 0.02 g/m² to about 1.5 g/m², preferably from about 0.1 g/m² to about 1.0 g/m², and more preferably from about 0.25 g/m² to about 0.75 g/m². The center zone can also be free of polymeric additive.

The present cleaning sheet can also have zones in addition to a center zone, such as one or more side zones. Preferably, the cleaning sheet has two side zones, each positioned on each side of the center zone as shown in FIG. 29. The side zones 96 typically span the length of the cleaning sheet 99 and have a width that is equal to the distance from the longitudinal edge 97 of the center zone to the longitudinal edge 98 of the cleaning sheet. However, it should be recognized that a side zone 96 need not span the total length of the cleaning sheet 99 and need not have a width that is equal to the distance from the longitudinal edge 97 of the center zone to the longitudinal edge 98 of the cleaning sheet.

The width of a side zone 96 generally depends upon the width of the cleaning sheet 99 itself. Also, when such a cleaning sheet 99 is used with a cleaning implement such as a floor mop 20 as described hereinbefore in FIGS. 1, 4, 5, and 6, the width of a side zone 95 is preferably dependent upon the distance between the longitudinal edge 97 of the center zone and the longitudinal edge 98 of the point at which the cleaning sheet is folded over top of the mop head 22 of the floor mop 20. In this case, the width of the center zone 95 is preferably equal to at least about the distance between the longitudinal edge 97 of the center zone and the longitudinal edge of the point at which the cleaning sheet is folded over top of the mop head 22 of the floor mop 20 in order to be attached to the mop head 22. Typically, the width of a side zone 96 will be equal to from about 2.5% to about 46%, preferably from about 5.8% to about 35%, and more preferably from about 11.6% to about 23.2%, of the total width of the cleaning sheet 99. In a preferred embodiment, the cleaning sheet 99 has a total width of about 8.625 inches, a center zone 95 positioned in the center of the cleaning sheet that has a width of from about 0.25 inches to about 4 inches, preferably from about 0.75 inches to about 3 inches, and more preferably from about 1.5 inches to about 2 inches, and two side zones 96, with each side zone 96 having a width of from about 0.25 inches to about 4 inches, preferably from about 0.5 inches to about 3 inches, and more preferably from about 1 inch to about 2 inches. The length of each side zone 96 is typically equal to from about 27% to about 100%, preferably from about 54% to about 97.7%, and more preferably from about 86% to about 95.4%, of the total length of the cleaning sheet 99. In a preferred embodiment, the cleaning sheet 99 has a total length of about 11 inches and each side zone 96 has a length of 11 inches also.

The level of polymeric additive applied in a side zone of a cleaning sheet as described herein is typically from about 0.1 g/m² to about 5.0 g/m², preferably from about 0.5 g/m² to about 3.0 g/m², and more preferably from about 1.0 g/m² to about 2.0 g/m².

A cleaning sheet that has both a center zone and one or more side zones, typically contains a polymeric additive that has a Coating Concentration Differential of from about 1% to about 90%, preferably from about 10% to about 60%, and more preferably from about 25% to about 40%; wherein the Coating Concentration Differential is calculated according to the following formula:

(level of additive in center zone (g/m²))/(level of additive in side zone (g/m²))×100%

In an alternative embodiment, the present cleaning sheets can have a polymeric additive that is uniformly distributed across at least one surface, or both surfaces, of the cleaning sheet. In this preferred embodiment, the optional powders as described hereinbefore can be applied in a center zone, as described hereinbefore, of the cleaning sheet in order to reduce the tackiness and improving glide of the cleaning sheet, while retaining the ability of the cleaning sheet to pick-up large particulate material from the surface being cleaned. In this embodiment, the powder is applied to the center zone of the cleaning sheet at a level of from about 0.1 g/m² to about 5.0 g/m², preferably from about 0.5 g/m² to about 3.0 g/m², and more preferably from about 1.0 g/m² to about 2.0 g/m².

The cleaning sheets of the present invention containing the present additives exhibit consumer-acceptable particulate pick-up, filming and/or streaking, and glide when used to clean household surfaces, especially kitchen and/or bathroom floors such as ceramic tile, vinyl tile, linoleum, hardwood floors, and the like.

When cleaning surfaces with the present cleaning sheets, it is important to have the ability to pick-up both large and small particulate material. Test methods for measuring small particulate material is described in section V.B, infra, and for measuring large particulate material is described in section V.C, infra. Preferably, the present cleaning sheets exhibit small particulate pick-up of at least about 35%, preferably at least about 45%, more preferably at least about 55%, and still more preferably at least about 60%, by weight of the small particulate material originally present on the surface. In addition, the present cleaning sheets preferably exhibit large particulate, wherein the large particulate soil is sand, pick-up of at least about 20%, preferably at least about 30%, more preferably at least about 40%, and still more preferably at least about 50%, by weight of the large particulate material originally present on the surface. The present cleaning sheets preferably exhibit large particulate, wherein the large particulate soil is mulch, pick-up of at least about 40%, preferably at least about 60%, more preferably at least about 70%, and still more preferably at least about 80%, by weight of the large particulate material originally present on the surface.

In addition, the Initial Glide Value and In-Use Glide Value of the cleaning sheet should be minimized to allow the cleaning to smoothly glide across the surface being cleaned. If the Initial Glide Value and/or In-Use Glide Value is too high, a consumer will have a difficult time in smoothly moving the cleaning sheet back and forth across the surface being cleaned. Preferably, the present cleaning sheets will have an Initial Glide Value of no greater than about 3.5, preferably no greater than about 2.0, more preferably no greater than about 1.5, and still more preferably no greater than about 1.0. Preferably, the present cleaning sheet will have an In-Use Glide Value of no greater than about 2.5, preferably no greater than about 1.5, more preferably no greater than about 1.0, and still more preferably no greater than about 0.5. Initial Glide Value and In-Use Glide Value is determined according to the Test Method described herein in section V.D, infra.

V. Test Methods

A. Texture Analyzer Method

The adhesive characteristics of Tack Value, Adhesive Work Value, Cohesive/Adhesive Ratio, and Stringiness Value, as described in Section IV.A.3 supra, are measured according to the following test method. A texture analyzer is used to measure the adhesive characteristics of a given additive as described herein. A texture analyzer is commercially available from Stable Micro Systems, Ltd. in Godalming, Surrey UK under the trade name TA.XT2 Texture Analyser. The TA.XT2 Texture Analyser is shown in FIG. 27 and incorporates the following features: instrument probe arm 101; stationary plate 102; acrylic probe 103, which is preferably a 1.5 inch diameter acrylic probe; probe attachment 104; sample holder 105; sliding stand 106; displacement transducer 107; control unit 108; and personal computer 109. The personal computer 109 (e.g. IBM PC) that is part of the TA.XT2 Texture Analyzer runs Texture Expert for Windows Software. The Texture Expert for Windows Software automatically calculates Tack Value, Adhesive Work Value, Cohesive/Adhesive Ratio, and Stringiness Value, as described in Section IV.A.3 supra.

A sample polymeric additive is analyzed using the TA.XT2 Texture Analyzer according to the following procedure. A sample is prepared in a 5 cm diameter sample holder 105 at a depth of 1.5 to 1.75 mm. If the sample is a hot melt, the correct number of grams are placed in the sample holder 105, melted, and allowed to cool. If the sample is dissolved in solvent, the correct amount is calculated based on % solids, added to the sample holder 105, and allowed to dry completely. The TA.XT2 Texture Analyser is calibrated according to the instruction manual before use. The acrylic probe 103 (e.g. 1.5″ diameter domed acrylic probe) to be used is cleaned and securely attached to the Texture Analyzer via the probe attachment 104. The settings of the TA.XT2 Texture Analyser are adjusted to the following levels:

Pre-speed: 2 mm/s
Post-speed: 2 mm/s
Trigger: 5.0-20.0 grams
Test time: 5 seconds

The Trigger is the initial downward pressure exerted on the sample by the acrylic probe. The sample holder 105 is held firmly in place while the acrylic probe 103 is lowered to contact the sample and the raised again to the starting position by the machine. A graph of the test results is generated by the personal computer 109 and the results are calculated from the graph.

B. Small Particulate Pick-up Performance Test

The ability of a cleaning sheet to pick-up particulate material from a surface is measured according to the following test method. This test method is performed by carrying out the following steps:

1. A soil is prepared to simulate the particulate material that is typically found on household surfaces. The soil used in this test method consists of the following: 0.50 g of vacuum cleaner soil (i.e. dirt collected from vacuum cleaner bags), 0.50 g of fluffy soil (composed of a 50/50 mix of finely shredded cellulose and vacuum cleaner soil), and 0.02 g of pet hair.

2. A vinyl flooring test surface area, which is approximately 1.5 meters x 21 meters, is then prepared for testing by pre-cleaning the vinyl flooring with a 20% isopropanol solution and buffing the surface of the vinyl flooring dry. After the surface is dry, clean the surface with a commerical Swiffer® implement and clean Swiffer® sheet to standardize the electrostatic charge on the surface.

3. The soil (described above) is weighed and then dispersed evenly across the surface of the pre-cleaned vinyl flooring within the test surface area of approximately 1.5 meters×21 meters.

4. A cleaning sheet to be tested is weighed and then placed on an implement with mop handle and pad, such as a Swiffer® implement. The surface of the vinyl flooring is then cleaned in the following pattern: Floor is swept using an up and down S-pattern. The first two thirds of the width of the floor is cleaned starting on the left front side and ending on the right two/thirds side. Halfway through the cycle, the mophead should be swiveled to change the leading edge from the front to the back (i.e. Flip Step). After switching the leading/trailing edge, soil may fall off the sheet. If this is the case the mop is run over the soil that has fallen off. Then, the floor is swept, continuing to follow the up and down S-pattern. Once the end of the surface is reached, push the mop straight forward until you come to the right back corner of the testing surface. Turn the mop head to the left and continue pushing across the back of the baseboard, cleaning the back one-thirds. Once the corner is reached, turn mop head to the left, and push it across the length of the flooring. Once the end of the surface is reached, turn mop head to the right and bring soil pile to the middle of the flooring. This cleaning pattern is depicted as follows:

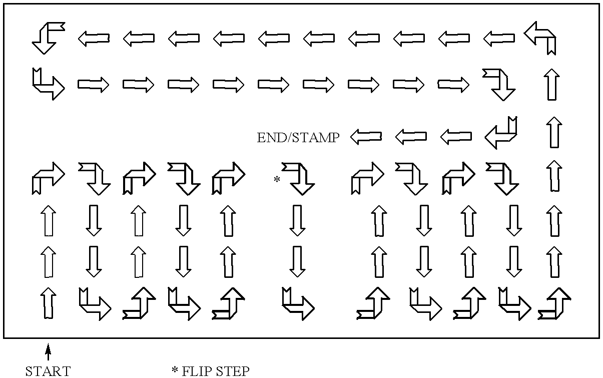

6. After Steps 1 and 2 have been completed, pick-up the mop head off the floor and carefully place it directly on top of the soil pile. With moderate pressure, push down on the soil pile and lift (i.e. Stamp).

7. Re-weigh the cleaning sheet on an analytical balance and record sheet weight.

8. Data is calculated and reported using the following formula:

% Sheet Pickup (Final Sheet Weight−Initial Sheet Weight)/(Soil Weight)×100

The test method is replicated 3 times, the results are averaged, and are reported as “SMALL PARTICULATE PICK-UP”.

C. Large Particulate Pick-up Performance Test

This test comprises the measuring of pick-up of different large particle soils, each weighed separately. Each soil is weighed separately in plastic weigh boats using an analytical balance. Although a variety of large particle soils can be used, the following soil types and amounts can be used:

(1) 1.5 g of sand (e.g. “Quikrete® Sand), sifted to 710 um-1.19 mm;

(2) 1.0 g of mulch (Ohio Mulch® Black Gold Mulch), spread on tray and tried in a fume hood for one day, and in a dessicator for one day, sifted to 710 m-6.3 mm;

(3) 0.75 g of Froot Loops® Cereal, crushed and sifted to 2.0-4.0 mm; or

(4) 2.0 g Combination Soil, composed of 0.5 g sand, 0.5 g mulch, 0.5 g Cereal, and 0.5 g Vacuum cleaner soil (i.e. dirt collected from vacuum cleaner bags).

Floor Preparation

A 6′×3′ section of vinyl flooring (e.g. Armstrong Signia Collection Flooring) is cleaned by wiping the entire surface with a 20% isopropyl alcohol solution and a paper towel. Before the soil is distributed, the surface is dried. The soil is spread evenly over the surface of the flooring by dispensing it directly from the weigh boat. Only one soil type of the appropriate weight is applied for each test (except in the case of the aforementioned combination soil). If performance for each soil type is desired, separate tests are performed.

General Procedure (See Diagram)

1. Once the floor is prepared for the test, weigh the sheet to be tested by placing it in a tared glass beaker on the analytical balance and record the weight. Place the sheet on the appropriate mop head (attached to the handle) and begin by placing the mop head in the lower left corner of the 6′×3′ floor, standing at a 3′ end.

2. Pushing the mop ahead using Edge A as the leading edge (see diagram), sweep along the edge of the floor until reaching the opposite end.

3. Stop, slide the mop to the right approximately six inches without turning it, and using Edge B as the leading edge, pull it back in a straight line down the floor to the 3′ end where mopping started.

4. Stop, slide the mop to the right six inches, and push it ahead again in a straight line to the opposite end of the floor. This process should be repeated until five passes have been made across the floor. The mop should end up in the upper right corner of the floor, compared to where the test started.

5. Keeping the mop in contact with the floor, stand in the upper left corner, turn the mop 90° to the left, and sweep the perimeter of the floor by pulling the mop towards the upper left corner, turning it at the corner, and pushing it ahead the rest of the way around the perimeter of the floor.

6. After mopping, carefully pick up the mop so that as little soil as possible falls from the sheet. Carefully fold the sheet with the soil inside and weight it again in the tared beaker on the same analytical balance.

7. Sweep the remaining soil from the floor using a brush or a vacuum cleaner before performing the next test. Wipe the floor clean with 20% IPA solution.

8. In order to get an accurate result, repeat each test with the same sheet or mop head being tested three to six times and take the average

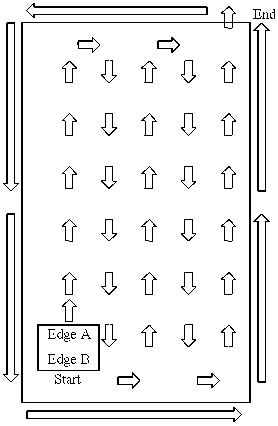

Calculations

The large particulate pick-up is calculated using the following formula:

% Sheet Pickup=(Final Sheet Weight−Initial Sheet Weight)/(Soil Weight)×100

The results of this test method (being an average of 3 replications) are shown below in Table 2 under the column beading “LARGE PARTICULATE PICK-UP”.

D. Glide Value

The following test method is used to derive two quantitative grades that reflect the ability of the cleaning sheet to glide smoothly and easily across a surface being cleaned. Initial Glide Value and In-Use Glide Value are measured according to this test method.

Initial Glide Value of a cleaning sheet is measured as follows. A cleaning sheet is placed securely on the mop head of a cleaning implement such as a floor mop. The floor mop is put down on vinyl flooring (e.g. Armstrong Signia Collection Flooring), which has been cleaned by wiping the entire surface of the vinyl flooring with a 20% isopropyl alcohol solution and a paper towel, in the area where sweeping begins. To begin sweeping, the floor mop is pushed forward across the surface of the vinyl flooring. The operator then quantitatively assess the degree to which the floor mop and cleaning sheet resists movement across the surface of the flooring, as well as the effort involved in moving the floor mop across the surface of the flooring from the initial starting point.

In-Use Glide Value of a cleaning sheet is measured as follows. During the sweeping motion there can be resistance to the mopping motion, or drag, as the floor mop and cleaning sheet move across the surface of the flooring. The operator then quantitatively assess the degree of resistance to the glide of the mop as it passes over the surface of the flooring, as well as when sweeping starts and stops during the procedure (as in the end of one pass and beginning of the next).

The following Grading Scale is used by the operator to quantify the glide values. For each of the two glide assessments described above, there is a grade given for that sheet or type of coating. The scale is 0 to 8 with whole number or half grades given. The following are the guidelines to use in the assessments.

| Grade | Initial Glide Value | In-Use Glide Value |
|---|---|---|
| 0 | no initial resistance | no resistance to glide |
| | noticed; little effort | while mopping |
| | required to move mop | |
| 2 | light to moderate | light resistance to |
| | resistance; some effort | glide noticed while |
| | required to move mop | mopping |
| 4 | moderate to heavy | moderate resistance |
| | resistance; moderate | to glide noticed while |
| | effort required to move | mopping |
| | the mop | |
| 6 | very heavy resistance; | heavy resistance to |
| | difficult to move the | glide noticed while |
| | mop | |
| | from starting position | mopping |
| 8 | extreme resistance; | extreme resistance to |
| | impossible to move the | glide; impossible to |
| | mop from the starting | move mop smoothly |
| | position | across the floor |

The following are non-limiting examples of the cleaning sheets and polymeric additives of the present invention.

### EXAMPLE IA

This Example shows the adhesive characteristics of a variety of polymeric additives of the present invention. The adhesive characteristics of each polymeric additive are measured according to the Texture Analyzer Test Method described hereinbefore in Section V.A with a pressure (i.e. Trigger) of 5.0 grams. The adhesive characteristics measured and/or reported include Tack Value, Adhesive Work Value, Cohesive/Adhesive Ratio, and Stringiness Value, and are reported in the following Table 1A.

TABLE 1A

| | | | Cohesive/ | |
|---|---|---|---|---|
| Polymeric | | Adhesive | Adhesive | Stringiness |
| Additive | Tack Value | Work Value | Ratio | Value |
| HL-1496^{a} | 254 | 298 | 4.89 | 8.14 |
| HL-1597^{a} | 154 | 206 | 3.72 | 3.82 |
| HL-1902^{a} | 215 | 304 | 0.42 | 3.87 |
| HL-1972^{a} | 287 | 219 | 1.77 | 2.71 |
| HL-2713^{a} | 296 | 508 | 5.05 | 5.17 |
| ROBOND | 178 | 498 | 0.27 | 6.27 |
| PS75R^{b} | | | | |
| PIB 85,000^{C} | 327 | 71 | 0.16 | 0.9 |

^{a}Pressure sensitive adhesive commerically available from H.B. Fuller Company.
^{b}Pressure sensitive adhesive commercially available from Rohm & Haas Company.
^{c}Polyisobutylene tacky polymer having a molecular weight of about 85,000.

### EXAMPLE IB

This Example shows the effect of increased pressure (i.e. Trigger) on the adhesive characteristics of a pressure sensitive adhesive sold under the trade name HL 1500 by the H B. Fuller Company. The adhesive characteristics are measured according to the Texture Analyzer Test Method described in Section V.A. with varying pressures (i.e. Trigger) as indicated in Table 1B. The adhesive characteristics measured include Tack Value, Adhesive Work Value, Cohesive/Adhesive Ratio, and Stringiness Value, and are reported in the following Table 1B.

TABLE 1B

| | | | | Cohesive/ | |
|---|---|---|---|---|---|
| Polymeric | Trigger | Tack | Adhesive | Adhesive | Stringiness |
| Additive | (grams) | Value | Work Value | Ratio | Value |
| HL 1500 | 5.0 | 239 | 60 | 1.54 | 0.84 |
| HL 1500 | 10.0 | 252 | 84 | 1.66 | 1.02 |
| HL 1500 | 15.0 | 392 | 137 | 0.49 | 1.06 |
| HL 1500 | 20.0 | 390 | 152 | 0.29 | 1.12 |

### EXAMPLE II

The following “Example Sheet A” exemplifies a heat-bonded cleaning sheet of the present invention, which contains a polymeric additive. Tables 2A and 2B provide the results of the Large Particulate Pick-up Performance Test (described in Section V.C. supra) and the Glide Value test method (described in Section V.D. supra) for the exemplified cleaning sheet containing a polymeric additive (as specified in Tables 2A and 2B), with the cleaning sheet being attached to a cleaning implement comprising a mop head with an elastic pad as described hereinbefore and shown in FIGS. 1, 4, 5, and 6. For the results shown in Table 2A, the polymeric additive is first dispersed or dissolved in a solvent, then the solution or dispersion is sprayed onto Example Sheet A, and the solvent is allowed to evaporate. For the results shown in Table 2B, the polymeric additive is applied to Example Sheet A via a hot melt spray.

### EXAMPLE SHEET A

This example describes a process of making a cleaning sheet as illustrated by the diagram of FIG. 24. During this process, a continuous first web 310 made of polypropylene having a width of 210 mm and a basis weight of 30 g/m² is continuously fed from left to right as viewed in the diagram. Simultaneously, a tow 312 comprising a bundle of 2,000-100,000 polyester continuous filaments 315 each of 2-30 deniers is continuously fed from left to right as viewed in the diagram. The tow 312 is opened or fibrillated by a set of expanding rolls 311 to form a continuous second web having a desired width and thereafter placed upon the first web 310. The first web 310 and the second web 312 are transported to a heating emboss machine 313 in which they are compressed together under heating and integrally heat-sealed along thereby formed heat seal lines 316 transversely extending to form a continuous composite third web 314. The heat-seal lines 316 are provided so as to be spaced apart one from another by a distance d as measured longitudinally on the third web, i.e., intermittently arranged longitudinally on the third web 314. Thereafter, the second web 312 is cut by a first cutter 317 along a middle line extending parallel to and between each pair of adjacent heat-seal lines 316 in two, thereby forming tufts of brushy filaments extending outwardly from the overall structure. Then, the first web 310 is cut by a second cutter 318 into a desired length. In this manner, the individual cleaning sheets 1 are obtained from the third web 314. In this process, the individual basic sheets 10 are obtained from the first web 310, the brushy filaments are obtained from the second web 312, the individual filaments 15 of the brushy filaments are obtained from the continuous filaments 315 and the anchoring portions 16 are provided by the heat-seal lines 316. Preferably, each of the heat-seal lines 316 has a width of 2-10 mm and is spaced apart from the adjacent heat-seal line by a distance d of 20-200 mm. The brushy filaments or the second web or the tow 312 prior to formation of these brushy filaments are coated with a polymeric additive of the present invention as described in Table 2 at an appropriate step of the process. In a section of the first web 310 to be cut by the second cutter 318, a distance D between each pair of adjacent heat-seal lines 316 may be dimensioned to be longer than the distance d to obtain a relatively large marginal region 7 facilitating the cleaning sheet 1 to be mounted on the holder 2. In this case, the section defined between two adjacent heat-seal lines spaced from each other by the distance D necessarily provides relatively long brushy filaments and these brushy filaments must be cut to a length in conformity of the remainder brushy filaments. According to the process illustrated, a length of each filament 15 hanging down from the anchoring portion 16 corresponds to ½ of the distance d. If desired, a length of the second web 312 fed on the section of the first web 310 defined between each pair of adjacent heat-seal lines 316 may be dimensioned to be longer than the distance d in order to obtain the filaments 15 longer than ½ of the distance d.

A cleaning sheet resulting from this process is shown in FIG. 23.

TABLE 2A

| | | Large Particulate Pick-Up | | | | Glide Value | |
|---|---|---|---|---|---|---|---|
| | | | | Froot | Combi- | | |
| Polymeric | Level | Sand | Mulch | Loops^{™} | nation | | In- |
| Additive | (g/m²) | Soil | Soil | Soil | Soil | Initial | Use |
| HL-1496^{a} | 1.12- | 47% | 93% | 69% | 55% | 2.125 | 2 |
| | 1.56 | | | | | | |
| HM-1597^{a} | 1.12- | 69% | 86% | 79% | 71% | 2.875 | 2.125 |
| | 1.56 | | | | | | |
| HM-1902^{a} | 1.12- | 78% | 96% | 87% | 68% | 3 | 2.375 |
| | 1.56 | | | | | | |
| HM-1972^{a} | 1.12- | 32% | 93% | 81% | 53% | 1.25 | 1 |
| | 1.56 | | | | | | |
| HM-2713^{a} | 1.12- | 60% | 93% | 82% | 59% | 1.375 | 0.625 |
| | 1.56 | | | | | | |
| ROBOND | 1.12- | 68% | 88% | 82% | 58% | 2.375 | 1.25 |
| PS75R^{b} | 1.56 | | | | | | |

^{a}Pressure sensitive adhesive commerically available from H. B. Fuller Company, which is applied to Example Sheet A via a toluene solution spray.
^{b}Pressure sensitive adhesive commercially available from Rohm & Haas Company,

which is applied to Example Sheet A via an aqueous dispersion spray.

TABLE 2B

| | | Large Particulate Pick-Up | | | | |
|---|---|---|---|---|---|---|
| | | | | Froot | | |
| Polymeric | Level | Sand | Mulch | Loops^{TM} | Glide Value | |
| Additive | (g/m²) | Soil | Soil | Soil | Initial | In-Use |
| HL-2713^{a} | 0.4 | 21 | 74 | 60 | 0.6 | 0.7 |
| | 0.6 | 28 | 92 | 81 | 0.9 | 0.9 |
| | 0.8 | 22 | 86 | 76 | 1.9 | 1.0 |
| | 1.0 | 24 | 81 | 77 | 2.3 | 1.1 |
| HL-1500^{a} | 0.6 | 25 | 87 | 61 | 0.5 | 0.5 |
| | 0.8 | 38 | 88 | 77 | 0.8 | 0.8 |
| | 1.0 | 25 | 88 | 77 | 0.9 | 0.6 |

^{a}Pressure sensitive adhesive commerically available from H.B. Fuller Company, which is applied to Example Sheet A via a hot melt spray.

What is claimed is:

1. A mop head for a cleaning implement, comprising:
a leading edge, a trailing edge, and a bottom surface for engaging a cleaning sheet; and
wherein said bottom surface of said mop head has a gap at least one of said leading edge or said trailing edge of at least about 1.5 mm.

2. The mop head of claim 1, wherein said gap is at least about 2 mm.

3. The mop head of claim 1, wherein said gap is between about 2 mm and about 5 mm.

4. The mop head of claim 1, wherein said bottom surface of said mop head has said gap at said leading edge and said trailing edge of said mop head.

5. The mop head of claim 1, wherein said bottom surface of said mop head has a contact surface whose width between said leading edge and said trailing edge is less than about 50 mm.

6. The mop head of claim 5, wherein the profile of said contact surface is substantially straight.

7. The mop head of claim 6, wherein said width of said contact surface is between about 2 mm and about 50 mm.

8. The mop head of claim 1, wherein said bottom surface of said mop head has a contact surface whose width between said leading edge and said trailing edge is less than about 25 mm.

9. The mop head of claim 1, wherein said bottom surface of said mop head has a contact surface whose contact surface ratio is less than about 70%.

10. The mop head of claim 1, wherein said bottom surface of said mop head has a contact surface whose contact surface ratio is between about 1% and about 5%.

11. The mop head of claim 1, wherein said bottom surface of said mop head has a contact surface whose contact surface ratio is between about 1% and about 2%.

12. The mop head of claim 1, wherein said bottom surface of said mop head has a contact surface which is substantially curved.

13. The mop head of claim 12, wherein said contact surface of said mop head has a radius of curvature.

14. The mop head of claim 13, wherein said radius of curvature is at least about 300 mm.

15. The mop head of claim 13, wherein said radius of curvature is at least about 1000 mm.

16. The mop head of claim 13, wherein the ratio of said gap to said radius of curvature is between about 0.5 and about 1000.

17. The mop head of claim 1, wherein a portion of said bottom surface of said mop head has a texture thereon.

18. The mop head of claim 1, wherein the profile of said bottom surface of said mop head comprises one or more steps.

19. The mop head of claim 1, wherein said mop head comprises a base and an elastic pad.

20. The mop head of claim 19, wherein said elastic pad is adhesively attached to said base.

21. The mop head of claim 19, wherein said elastic pad is formed from a material selected from the group consisting of polyurethane, ethylene-vinyl acetate copolymer, and mixtures thereof.

22. The mop head of claim 21, wherein said elastic pad is formed of a ethylene-vinyl acetate copolymer.

23. The mop head of claim 22, wherein said elastic pad is compression molded.

24. A cleaning implement, comprising:
a handle;
a pivotable joint attached to said handle;
a mop head according to claim 1, said mop head attached to said pivotable joint.

25. The cleaning implement of claim 24, further comprising a cleaning sheet.

26. The cleaning implement of claim 25, wherein the ratio of the caliper of said sheet to said gap is between about 0 and about 0.65.

27. The cleaning implement of claim 24, further comprising a coupling having three legs for changing the orientation between said pivotable joint and said handle, wherein at least on of said handle or said pivotable joint can releaseably engage at least two of said legs.

28. A cleaning implement for use with a cleaning sheet which is also suitable for hand dusting, comprising:
a handle;
a pivotable joint attached to said handle;
a mop head attached to said pivolable joint, said mop head having a leading edge, a trailing edge, and a bottom surface for engaging a cleaning sheet; and
wherein said mop head has a length of at least about 400 mm and a length to width ratio between about 0.3 and about 1.

29. The cleaning implement of claim 28, wherein said bottom surface of said mop head has a gap at least one of said leading edge or said trailing edge of at least about 1.5 mm.

30. A cleaning implement, comprising:
a handle;
a pivotable joint attached to said handle;
a mop head attached to said pivotable joint, said mop head having a leading edge, a trailing edge, and a bottom surface for engaging a cleaning sheet, wherein said bottom surface of said mop head has a gap at least one of said leading edge or said trailing edge; and
a cleaning sheet attached to said mop head, wherein the ratio of the caliper of said sheet to said gap is between about 0 and about 0.65.

31. The cleaning implement of claim 30, wherein said ratio of the caliper of said sheet to said gap is between about 0.1 and about 0.6.

32. A cleaning implement, comprising:
a handle;
a pivotable joint attached to said handle;
a mop head attached to said pivotable joint, said mop head having a leading edge, a trailing edge; and
a cleaning sheet attached to said mop head around said leading edge and said trailing edge of said mop head, said cleaning sheet having a bottom surface,
wherein said bottom surface of said cleaning sheet has a gap at least one of said leading edge or said trailing edge of said mop head of at least about 1.5 mm.

33. The cleaning implement of claim 32, wherein said gap is at least about 2 mm.

34. The cleaning implement of claim 32, wherein said gap is between about 2 mm and about 10 mm.

35. A kit for a cleaning implement, comprising:
a mop head having a pivotable joint, said mop head having a leading edge, a trailing edge, and a bottom surface for engaging a cleaning sheet, wherein said mop head has a gap at least one of said leading edge or said trailing edge of at least about 1.5 mm; and
a coupling having three bores, wherein at least one of said handle or said pivotable joint can releaseably engage at least two of said bores.

36. A package, comprising a cleaning sheet suitable for hand dusting and suitable for use with a floor mop having a mop head, said cleaning sheet comprising a substrate having a length of at least about 400 mm and wherein the ratio of the length to the width of the sheet is between about 0.4 and about 1.

37. The package of claim 36, further comprising a set of instructions in association with the package, the set of instructions comprising an instruction to use the cleaning sheet with a floor mop.

38. A cleaning sheet comprising:
(a) a substrate; and
(b) a polymeric additive selected from the group consisting of pressure sensitive adhesive, tacky polymer, and mixtures thereof;
wherein said polymeric additive is incorporated onto said substrate at a level of from about 0.1 g/m² to about 10.0 g/m².

39. The cleaning sheet of claim 38, wherein said polymeric additive is incorporated onto said substrate at a level of from about 0.3 g/m² to about 6.0 g/m².

40. The cleaning sheet of claim 39, wherein said polymeric additive is incorporated onto said substrate at a level of from about 0.5 g/m² to about 4.0 g/m².

41. The cleaning sheet of claim 38, wherein said polymeric additive is a pressure sensitive adhesive comprising:
(a) an adhesive polymer;
(b) optionally, a tackifying resin;
(c) optionally, a plasticizer; and
(d) optionally, a component selected from the group consisting of diluents, stabilizers, antioxidants, colorants, fillers, and mixtures thereof.

42. The cleaning sheet of claim 38, wherein said polymeric additive is a tacky polymer selected from the group consisting of: polyisobutylene polymers, alkyl methacrylate polymers, polyalkyl acrylates, and mixtures thereof.

43. A cleaning sheet comprising:
(a) a substrate; and
(b) a pressure sensitive adhesive incorporated onto said substrate, said pressure sensitive adhesive comprising:
(i) an adhesive polymer;
(ii) optionally, a tackifying resin;
(iii) optionally, a plasticizer; and
(iv) optionally, a component selected from the group consisting of diluents, stabilizers, antioxidants, colorants, fillers, and mixtures thereof;
wherein said pressure sensitive adhesive has an Adhesive Work Value of from about 130 to about 1000.

44. The cleaning sheet of claim 43, wherein said Adhesive Work Value from about 160 to about 750.

45. The cleaning sheet of claim 44, wherein said Adhesive Work Value from about 250 to about 650.

46. The cleaning sheet of claim 43, wherein said pressure sensitive adhesive has an additional adhesive characteristic selected from the group consisting of:
(a) a Tack Value of from about 100 to about 500;
(b) a Cohesive/Adhesive Ratio of from about 0.2 to about 20;
(c) a Stringiness Value of from about 2.5 to about 12.0; and
(d) combinations thereof.

47. The cleaning sheet of claim 46, wherein said pressure sensitive adhesive has a Tack Value of from about 150 to about 400.

48. The cleaning sheet of claim 43, wherein said adhesive polymer is selected from the group consisting of block co-polymers containing polystyrene endblocks, and polyisoprene, polybutadiene, and/or poly ethylene-butylene midblocks; polyolefins such as polyethylene, polypropylene, amorphous polypropylene, polyisoprene, and polyethylene propylene; ethylene-vinylacetate copolymers, polyisobutylene; poly(vinyl ethylene-co-1,4-butadiene); natural rubber [poly cis-isoprene]; polyacrylic acid, preferably 2-ethylhexylacrylate and iso-octlyacrylate, and polymethacrylic acid or their salt; polydimethylsiloxane, polydiphenylsiloxane, poly methyl phenyl siloxane; polyvinyl alcohol; and
mixtures thereof.

49. The cleaning sheet of claim 43, wherein said adhesive polymer is a cross-linked acrylate polymer.

50. A cleaning sheet comprising:
(a) a substrate; and
(b) a tacky polymer;
wherein said tacky polymer has an said Adhesive Work Value is from about 50 to about 1000.

51. The cleaning sheet of claim 50, wherein said Adhesive Work Value is from about 75 to about 250.

52. The cleaning sheet of claim 51, wherein said Adhesive Work Value is from about 100 to about 150.

53. The cleaning sheet of claim 50, wherein said tacky polymer has a T_{g} of from about −150° C. to about 0° C.

54. The cleaning sheet of claim 50, wherein said tacky polymer has a molecular weight of from about about 1000 to about 500,000.

55. The cleaning sheet of claim 50, wherein said tacky polymer has an additional adhesive characteristic selected from the group consisting of:
(a) a Tack Value of from about 300 to about 500;
(b) a Cohesive/Adhesive Ratio of from about 0.2 to about 20;
(c) a Stringiness Value of from about 0.4 to about 12.0; and
(d) combinations thereof.

56. The cleaning sheet of claim 50, wherein said tacky polymer is selected from the group consisting of polyisobutylene polymers, alkyl methacrylate polymers, polyalkyl acrylates, and mixtures thereof.

57. The cleaning sheet of claim 56, wherein said tacky polymer is polyisobutylene polymer.

58. A cleaning sheet comprising:
(a) a substrate; and
(b) a polymeric additive selected from the group consisting of pressure sensitive adhesive, tacky polymer, and mixtures thereof;
wherein said polymeric additive is incorporated onto said substrate in zones comprising a center zone and two side zones; wherein said side zones are located on each side of said center zone; wherein the level of said polymeric additive in said center zone is from about 0 g/m² to about 1.5 g/m²; and
wherein the level of said polymeric additive in said side zones is from about 0.1 g/m² to about 5.0 g/m².

59. The cleaning sheet of claim 58, wherein said polymeric additive is a pressure sensitive adhesive and has an Adhesive Work Value of from about 130 to about 1000.

60. The cleaning sheet of claim 58, wherein said polymeric additive is a tacky polymer and has an Adhesive Work Value of from about 50 to about 1000.

61. A cleaning implement comprising:
(a) a cleaning sheet comprising:
(i) a substrate; and
(ii) a polymeric additive selected from the group consisting of pressure sensitive adhesive, tacky polymer, and mixtures thereof;
(b) a mop head comprising a leading edge, a trailing edge, and a bottom surface for engaging said cleaning sheet;
wherein said bottom surface of said mop head has a gap at least one of said leading edge or said trailing edge of at least about 1.5 mm; and wherein said polymeric additive is incorporated onto said substrate in zones comprising a center zone and two side zones; wherein said side zones are located on each side of said center zone; wherein the level of said polymeric additive in said center zone is from about 0 g/m² to about 1.5 g/m²; and wherein the level of said polymeric additive in said side zones is from about 0.1 g/m² to about 5.0 g/m².

62. The cleaning implement of claim 61, wherein said polymeric additive is a pressure sensitive adhesive and has an Adhesive Work Value of from about 130 to about 1000.

63. The cleaning implement of claim 61, wherein said polymeric additive is a tacky polymer and has an Adhesive Work Value is from about 50 to about 1000.
